(19) United States
(12) Patent Application Publication
(10) Pub. No.: US 2016/0117592 A1
(43) Pub. Date: Apr. 28, 2016

(54) EFFECTIVE RESPONSE PROTOCOLS RELATING TO HUMAN IMPAIRMENT ARISING FROM INSIDIOUS HETEROGENEOUS INTERACTION

(71) Applicant: Elwha LLC, Bellevue, WA (US)

(72) Inventors: Edward K.Y. Jung, Bellevue, WA (US); Royce A. Levien, Lexington, MA (US); Richard T. Lord, Gig Harbor, WA (US); Robert W. Lord, Seattle, WA (US); Mark A. Malamud, Seattle, WA (US); Clarence T. Tegreene, Mercer Island, WA (US)

(73) Assignee: Elwha LLC, a limited liability company of the State of Delaware

(21) Appl. No.: 14/522,723

(22) Filed: Oct. 24, 2014

(51) Int. Cl. G06N 5/04; G06N 99/00

(52) U.S. Cl. CPC G06N 5/04; G06N 99/005

(57) ABSTRACT

Structures and protocols are presented for using an identification of a first entity (an individual) or a second entity (a device or individual, e.g.), and an indication of the first entity not reacting positively (apparently taking offense, e.g.) to an action or expression of the second entity, for triggering one or more decision such as (1) whether or not to discard a recorded data component of a communicative expression of the second entity or (2) whether or not to facilitate a communication to a third entity or (3) whether or not to adjust a performance evaluation of the second party or of content from the second party or (4) whether or not to signal a disruptive emission in a vicinity of the second party.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

Not applicable.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and of any and all parent, grandparent, great-grandparent, etc. applications of the Priority Applications, including any priority claims, is incorporated herein by reference to the extent such subject matter is not inconsistent herewith.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications, to the extent such subject matter is not inconsistent herewith.

Under the auspices of various alleged “rules” implementing the America Invents Act (AIA), the United States Patent and Trademark Office (USPTO) is purporting to require that an Attorney for a Client make various legal and/or factual statements/commentaries/admissions (e.g. Concerning any “Statement under 37 CFR 1.55 or 1.78 for AIA (First Inventor to File) Transition Application”) related to written description/new matter, and/or advise his Client to make such legal and/or factual statements/commentaries/admissions. Attorney expressly points out that the burden of both alleging that an application contains new matter with respect to its parent(s) and establishing a prima facie case of lack of written description under 35 U.S.C. §112, first paragraph lies firmly on the USPTO. Accordingly, and expressly in view of duties owed his client, Attorney further points out that the AIA legislation, while referencing the first to file, does not appear to constitute enabling legislation that would empower the USPTO to compel an Attorney to either make/advise such legal and/or factual statements/commentaries/admissions. Notwithstanding the foregoing, Attorney/Applicant understand that the USPTO's computer programs/personnel have certain data entry requirements, and hence Attorney/Applicant have provided a designation(s) of a relationship between the present application and its parent application(s) as set forth herein and in any ADS filed in this application, but expressly points out that such designation(s) are not to be construed in any way as any type of commentary and/or admission as to whether or not a claim in the present application is supported by a parent application, or whether or not the present application contains any new matter in addition to the matter of its parent application(s) in general and/or especially as such might relate to an effective filing date before, on, or after 16 Mar. 2013.

Insofar that the Attorney/Applicant may have made certain statements in view of practical data entry requirements of the USPTO should NOT be taken as an admission of any sort. Attorney/Applicant hereby reserves any and all rights to contest/contradict/confirm such statements at a later time. Furthermore, no waiver (legal, factual, or otherwise), implicit or explicit, is hereby intended (e.g., with respect to any statements/admissions made by the Attorney/Applicant in response to the purported requirements of the USPTO related to the relationship between the present application and parent application[s], and/or regarding new matter or alleged new matter relative to the parent application[s]). For example, although not expressly stated and possibly despite a designation of the present application as a continuation-in-part of a parent application, Attorney/Applicant may later assert that the present application or one or more of its claims do not contain any new matter in addition to the matter of its parent application[s], or vice versa.

### TECHNICAL FIELD

This disclosure relates to monitoring and response technologies for addressing contexts of heterogeneous interaction (between dissimilar entities, e.g.) insidiously resulting in harm.

### SUMMARY

More people than ever are interacting across lines of ethnicity, ideology, occupation, language, disability, age, economic status, and other attributes by which people distinguish themselves. Although such differences may enrich our lives, the trend toward heterogeneous interaction has also created innumerable opportunities for one person to have a negative reaction (of anxiety or sadness, e.g.) resulting from what another entity says or does. The cumulative effect of commonplace, unintendedly harmful actions (subtly offensive forms of device operation, e.g.) and expressions (microaggressions, e.g.) impairs the lives of many members of society substantially and often avoidably. Although denigrating and ignoring such problems is attractive for many, it is a hope and expectation of this writing that intelligence amplification and related technologies described herein may help willing individuals and institutions to address negative aspects of heterogeneous interactions in a significant and cost-effective way.

In one or more various aspects, a method includes but is not limited to obtaining an identification of a first entity (an individual, e.g.) or of a second entity (a device or individual, e.g.). Partly based on the identification and partly based on an indication of the first entity not reacting positively to an action or expression of the second entity, the method also includes deciding one or more of (1) whether or not to discard a recorded data component of a communicative expression of the second entity or (2) whether or not to facilitate a communication to a third entity or (3) whether or not to adjust a performance evaluation of the second party or of content from the second party or (4) whether or not to signal a disruptive emission in a vicinity of the second party or (5) other such useful outcomes described herein. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein referenced method aspects. The circuitry and/or programming may be virtually any combination of hardware, software (e.g., a high-level computer program serving as a hardware specification), and/or firmware configured to effect the herein referenced method aspects depending upon the design choices of the system designer, and limited to patentable subject matter under 35 U.S.C. 101.

In one aspect, a system includes but is not limited to circuitry configured to obtain an identification of a first entity (an individual, e.g.) or of a second entity (a device or individual, e.g.). Partly based on the identification and partly based on an indication of the first entity not reacting positively to an action or expression of the second entity, the system also includes circuitry configured to decide one or more of (1) whether or not to discard a recorded data component of a communicative expression of the second entity or (2) whether or not to facilitate a communication to a third entity or (3) whether or not to adjust a performance evaluation of the second party or of content from the second party or (4) whether or not to signal a disruptive emission in a vicinity of the second party or (5) other such useful outcomes described herein. In addition to the foregoing, other system aspects are described in the claims, drawings, and text forming a part of the disclosure set forth herein.

In one aspect, a computer program product may be expressed as an article of manufacture that bears instructions including, but not limited to, obtaining an identification of a first entity or a second entity. Partly based on the identification and partly based on an indication of the first entity not reacting positively to an action or expression of the second entity, one or more additional instructions trigger deciding one or more of (1) whether or not to discard a recorded data component of a communicative expression of the second entity or (2) whether or not to facilitate a communication to a third entity or (3) whether or not to adjust a performance evaluation of the second party or of content from the second party or (4) whether or not to signal a disruptive emission in a vicinity of the second party or (5) other such useful outcomes described herein. Alternatively or additionally, in some variants, the article of manufacture includes but is not limited to a tangible medium configured bear a device-detectable implementation or output manifesting an occurrence of the method(s) described above. In addition to the foregoing, other computer program products are described in the claims, drawings, and text forming a part of the disclosure set forth herein.

In addition to the foregoing, various other method and/or system and/or program product aspects are set forth and described in the text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF SEVERAL VIEWS OF THE DRAWING

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here. The following is a brief description of the several views of the drawings as described in 37 CFR 1.74, 37 CFR 1.77(b)(9), and 37 CFR 1.84:

FIG. 1 depicts an exemplary environment in which one or more technologies may be implemented, including a device in a vicinity of a first party (“Moni”) and a second party (“Donald”).

FIG. 2 depicts an exemplary environment in which one or more technologies may be implemented, including transistors and other integrated circuitry.

FIG. 3 comprises a 9-sheet depiction of an environment in which several entities, including “first” and “second” parties, may interact via various networks (and in which several component views are labeled as FIGS. 3-A through 3-I).

FIG. 3-A comprises a portion of FIG. 3 that depicts a 3×3 grid of view identifiers of the nine respective component views of FIG. 3 and also a call center operated by a service provider.

FIG. 3-B comprises a portion of FIG. 3 that depicts one or more components that reside on a medium of the interchange of FIG. 3-E and also a party affiliate.

FIG. 3-C comprises a portion of FIG. 3 that depicts components of a device used by or for the second party.

FIG. 3-D comprises a portion of FIG. 3 that depicts the first party, a device used by or for the first party, and a party affiliate of the first party.

FIG. 3-E comprises a portion of FIG. 3 that depicts an interchange: a network or other structure by which various entities of FIG. 3 may interact.

FIG. 3-F comprises a portion of FIG. 3 that depicts the second party and a device used by or for the second party.

FIG. 3-G comprises a portion of FIG. 3 that depicts one or more expressions manifested at the device used by or for the first party as well as an archive residing on a server.

FIG. 3-H comprises a portion of FIG. 3 that depicts event-sequencing logic implemented (in a server or satellite, e.g.) at the interchange.

FIG. 3-I comprises a portion of FIG. 3 that depicts a memory or other medium implemented (in a server or satellite, e.g.) at the interchange.

FIG. 4 depicts an exemplary environment in which one or more technologies may be implemented, including a network operably coupled with a kiosk (in a vicinity that may be visited by a client, e.g.).

FIG. 5 depicts an exemplary environment in which one or more technologies may be implemented, including a schematic depiction of a data handling medium.

FIG. 6 depicts an exemplary environment in which one or more technologies may be implemented, including a schematic depiction of event-sequencing logic.

FIG. 7 depicts an exemplary environment in which one or more technologies may be implemented, including a primary unit operably coupled with a secondary unit.

FIG. 8 depicts an exemplary environment in which one or more technologies may be implemented, including a schematic depiction of event-sequencing logic.

FIG. 9 depicts an exemplary environment in which one or more technologies may be implemented, including a schematic depiction of a data handling medium.

### DETAILED DESCRIPTION

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog®-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software (e.g., a high-level computer program serving as a hardware specification)).

Importantly, although the operational/functional descriptions described herein are understandable by the human mind, they are not abstract ideas of the operations/functions divorced from computational implementation of those operations/functions. Rather, the operations/functions represent a specification for massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to a human reader. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail herein, these logical operations/functions are not representations of abstract ideas, but rather are representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood by a human reader). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of logic, such as Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configurations, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). Thus, programs written in machine language—which may be tens of millions of machine language instructions long—are incomprehensible to most humans. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that useful, tangible, and concrete work is done. For example, as indicated above, such machine language—the compiled version of the higher-level language—functions as a technical specification which selects out hardware logic gates, specifies voltage levels, voltage transition timings, etc., such that the useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality of logic(s), or (d) virtually any combination of the foregoing. Indeed, any physical object which has a stable, measurable, and changeable state may be used to construct a machine based on the above technical description. Charles Babbage, for example, constructed the first mechanized computational apparatus out of wood, with the apparatus powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language should not be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In a general sense, those skilled in the art will recognize that the various embodiments described herein can be implemented, individually and/or collectively, by various types of electro-mechanical systems having a wide range of electrical components such as hardware, software (e.g., a high-level computer program serving as a hardware specification), firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software (e.g., a high-level computer program serving as a hardware specification), firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc. . . . ), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software (e.g., a high-level computer program serving as a hardware specification), and/or firmware.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, Verizon, AT&T, etc.), or (g) a wired/wireless services entity (e.g., Sprint, AT&T, Verizon, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software (e.g., a high-level computer program serving as a hardware specification) components that deliver or assist in the delivery of computational and/or storage capacity, including, but not limited to, one or more of a client, an application, a platform, an infrastructure, and/or a server The cloud may refer to any of the hardware and/or software (e.g., a high-level computer program serving as a hardware specification) associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, an application back-end, and/or a programmed application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more program, module, and/or development tools hosted on an infrastructure (e.g., a computing platform and/or a solution stack from which the client can create software-based interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

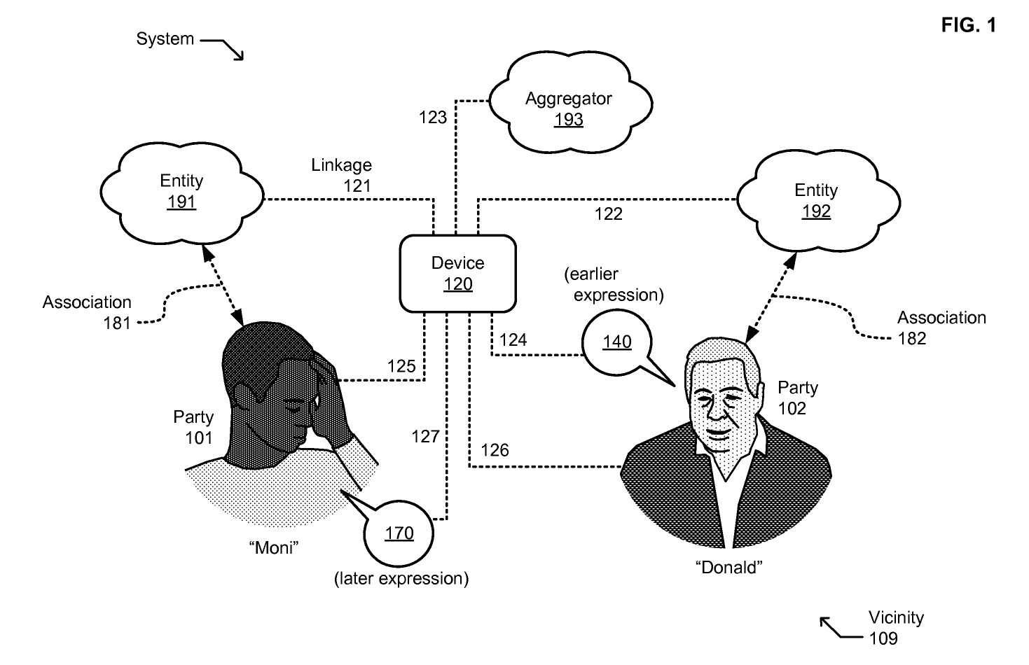

Referring now to FIG. 1, there is shown a system in which one or more technologies may be implemented. As shown, a “first” party 101 (“Moni”) makes a statement or other expression 170 after (apparently in response to, e.g.) an earlier, potentially harmful expression 140 was made by a “second” party 102 (“Donald”). A device 120 in their vicinity 109 is configured to observe or otherwise interact (via respective linkages 121-127 as shown, e.g.) with such parties 101, 102 and expressions 140, 170 and entities 191, 192 with respective associations 181, 182 with the parties (reflecting familial or occupational interests, e.g.). Alternatively or additionally, one or both of such types of expression 140, 170 or an event sequence combining attributes of each may be device detectable (at search engine provider or other aggregator 193, e.g.) as useful communicative indicia (of offendedness or offensiveness at least weakly correlated with that expression or sequence, e.g.) in light of teachings herein.

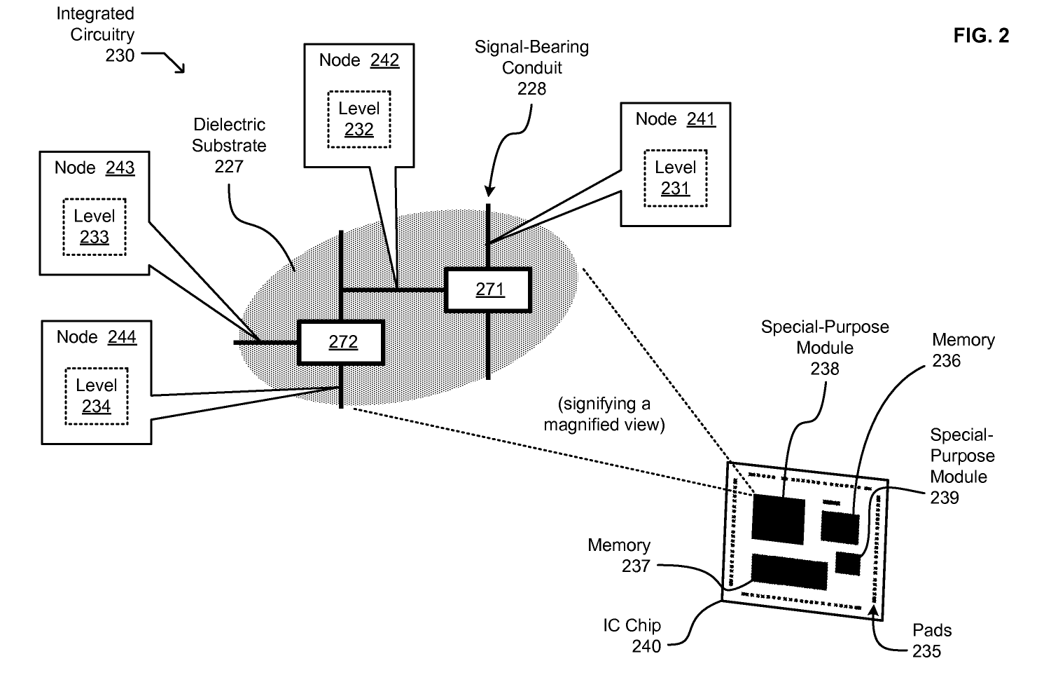

With reference now to FIG. 2, shown is another example of a system in which one or more technologies may be implemented. Integrated circuitry 230 within integrated circuit (IC) chip 240 includes transistors 271, 272 each formed onto a single dielectric substrate 227. Transistor 271, for example, comprises a control terminal (a gate or base, e.g.) at node 242 and two end terminals (at nodes 241, 243) as shown. Such formation may be achieved by a series of several lithographic processes (chemical and thermal and optical treatments for applying and treating and etching dielectrics or dopants or other materials, e.g.). Many millions of such transistors 271, 272 are linked in a network of signal-bearing conduits 228 (forked or other serpentine signal traces, e.g.) according to intricate circuit designs formed of circuit blocks of a same general type as those described herein. Even among the relatively complex circuit blocks presented herein in context, however, many such blocks are linked by electrical nodes 241, 242, 243, 244 each having a corresponding nominal voltage level 231, 232, 233, 234 that is spatially uniform generally throughout the node (within a device or local system as described herein, e.g.). Such nodes (lines on an integrated circuit or circuit board, e.g.) may each comprise a forked or other signal path (adjacent one or more transistors 271, 272, e.g.). Moreover many Boolean values (yes-or-no decisions, e.g.) may each be manifested as either a “low” or “high” voltage, for example, according to a complementary metal-oxide-semiconductor (CMOS), emitter-coupled logic (ECL), or other common semiconductor configuration protocol. In some contexts, for example, one skilled in the art will recognize an “electrical node set” as used herein in reference to one or more electrically conductive nodes upon which a voltage configuration (of one voltage at each node, for example, with each voltage characterized as either high or low) manifests a yes/no decision or other digital data. A few of the electrical nodes thereof (comprising pads 235 along the sides as shown, e.g.) provide external connectivity (for power or ground or input signals or output signals, e.g.) via bonding wires, not shown. Significant blocks of integrated circuitry 230 on IC chip 240 include special-purpose modules 238, 239 (comprising a sensor or other hard-wired special-purpose circuitry as described below, e.g.); and different structures of memory 236, 237 (volatile or non-volatile, e.g.) interlinked by numerous signal-bearing conduits 228 (each comprising an internal node, e.g.) and otherwise configured as described below.

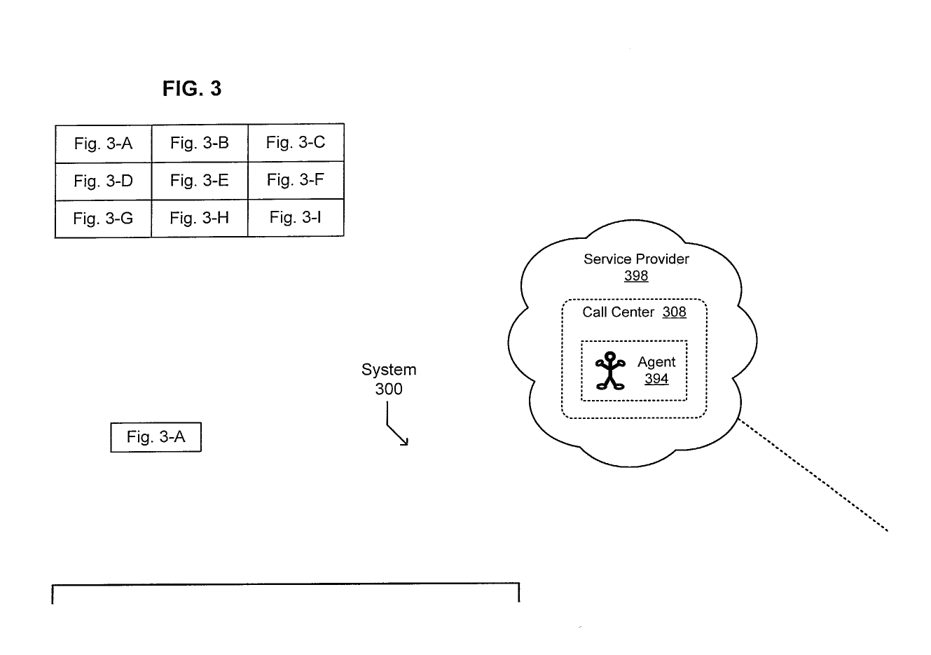

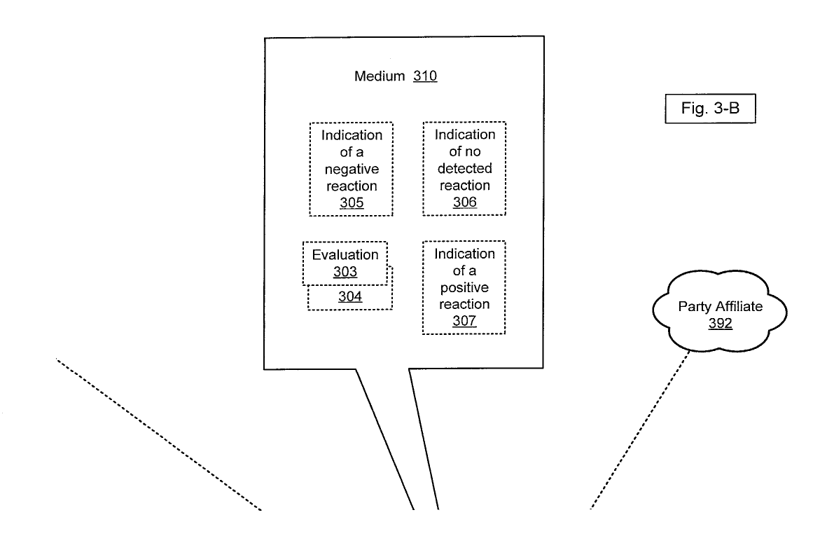

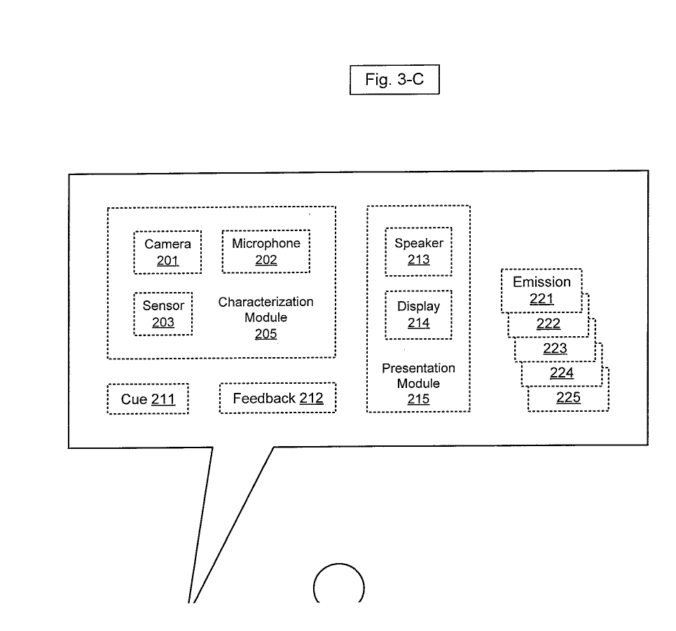

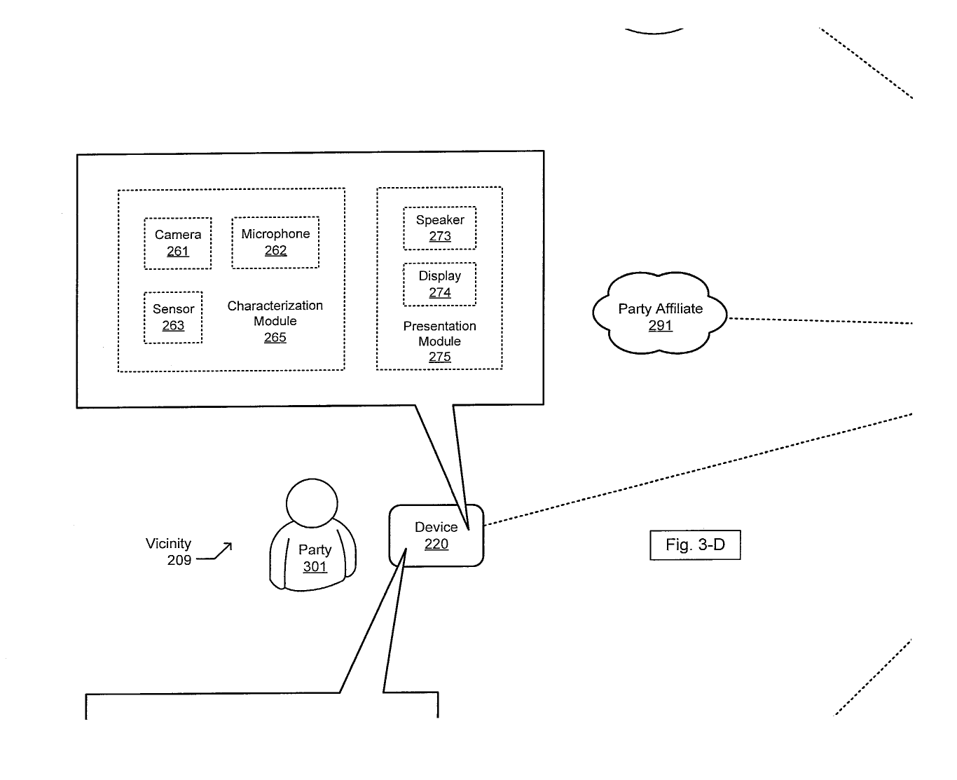

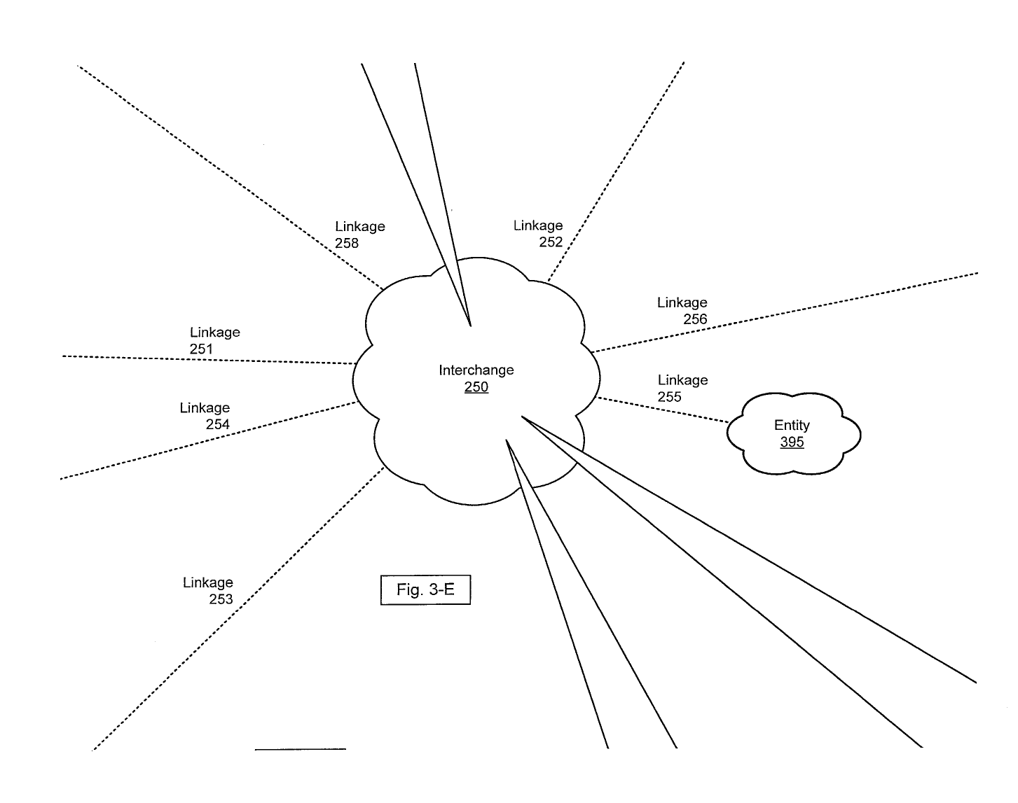

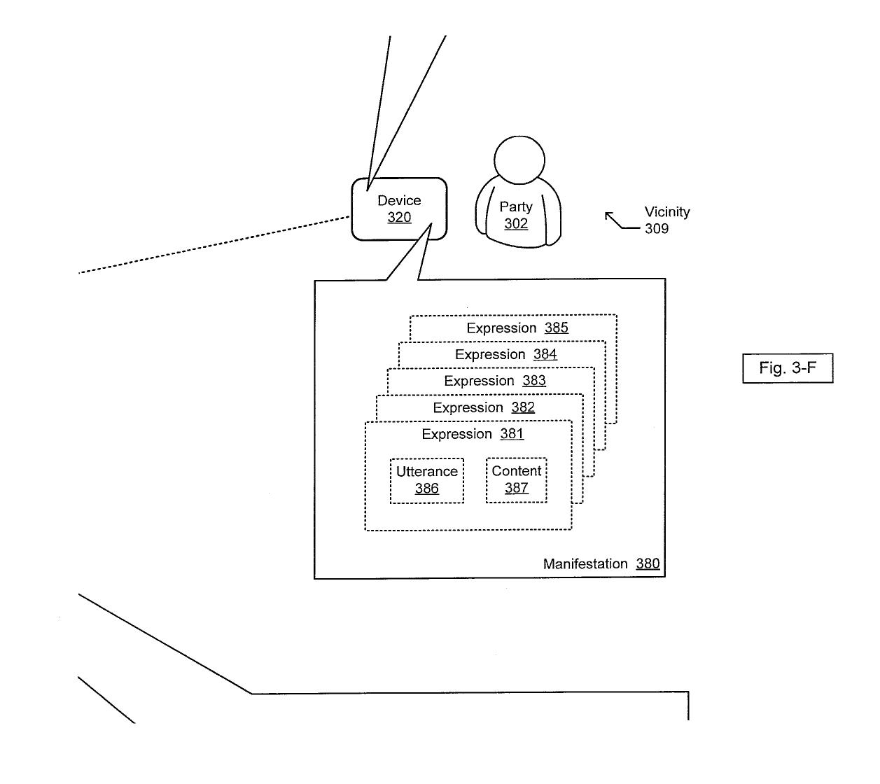

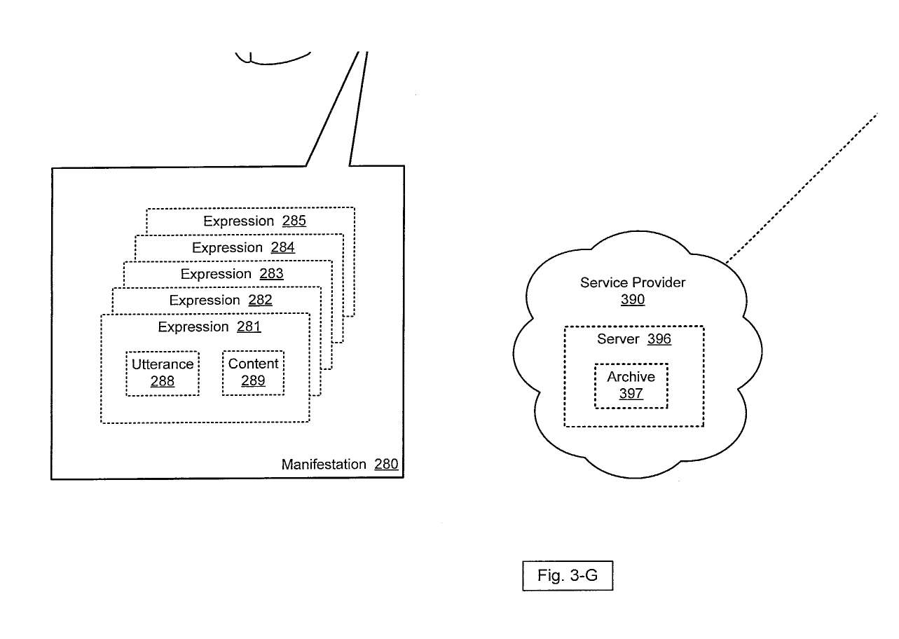

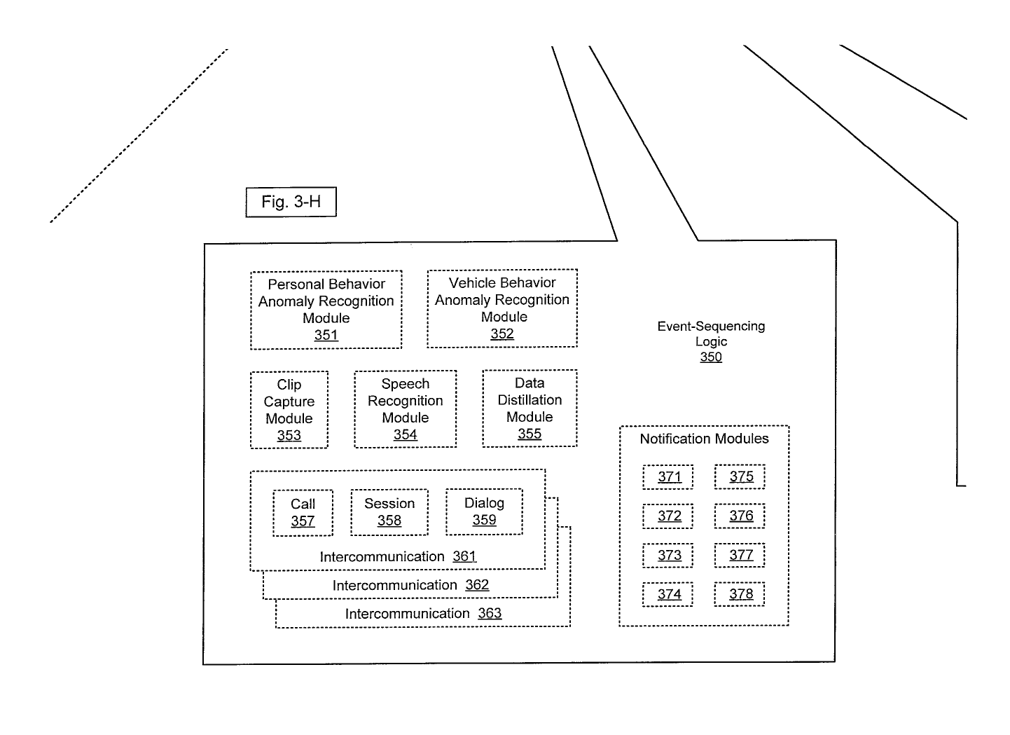

With reference now to FIG. 3, there is shown a high-level environment diagram depicting a system 300 in which one or more instances of integrated circuitry 230 or components thereof may be instantiated (in subsystems or devices 120 described herein, e.g.) and in which one or more technologies may be implemented. In accordance with 37 CFR 1.84(h)(2), FIG. 3 shows “a view of a large machine or device in its entirety . . . broken into partial views . . . extended over several sheets” labeled FIGS. 3-A through 3-I (Sheets 3-11). The “views on two or more sheets form, in effect, a single complete view, [and] the views on the several sheets . . . [are] so arranged that the complete figure can be assembled” from “partial views drawn on separate sheets . . . linked edge to edge,” in that (i) a “smaller scale view” is “included showing the whole formed by the partial views and indicating the positions of the parts shown,” see 37 CFR 1.84(h)(2), and (ii) the partial-view FIGS. 3-A to 3-I are ordered alphabetically, by increasing column from left to right, as shown here:

TABLE 1
Table showing alignment of enclosed partial view drawings to form
a single complete view of one or more environments.

| | | |
|---|---|---|
| FIG. 3-A | FIG. 3-B | FIG. 3-C |
| FIG. 3-D | FIG. 3-E | FIG. 3-F |
| FIG. 3-G | FIG. 3-H | FIG. 3-I |

In accordance with 37 C.F.R. §1.84(h)(2), FIG. 3 is “ . . . a view of a large machine or device in its entirety . . . broken into partial views . . . extended over several sheets . . . [with] no loss in facility of understanding the view.” The partial views drawn on the several sheets indicated in the above table are capable of being linked edge to edge, so that no partial view contains parts of another partial view. (In addition, a smaller scale view has been included, showing the whole formed by the partial views and indicating the positions of the individual sheets in forming the complete view.) As here, “where views on two or more sheets form, in effect, a single complete view, the views on the several sheets are so arranged that the complete figure can be assembled without concealing any part of any of the views appearing on the various sheets.” 37 C.F.R. §1.84(h)(2).

It is noted that one or more of the partial views of the drawings may be blank, or may not contain substantive elements (e.g., may show only lines, connectors, and the like). These drawings are included in order to assist readers of the application in assembling the single complete view from the partial sheet format required for submission by the USPTO, and, while their inclusion is not required and may be omitted in this or other applications, their inclusion is proper, and should be considered intentional.

Because FIG. 3 is a high-level environment diagram, some elements of system 300 are expressed through the function they carry out. In such circumstances, these elements should be considered to include any combination of one or more program, microprocessor configuration, state machine, transistor-based event sequencing structure, firmware, field-programmable gate array (“FPGA”) configuration, application programming interface (“API”), function, class, data structure, dynamically loaded library (“DLL”), database (e.g., SQL database), or other such special-purpose modules implemented in a structure or method eligible for patent protection under 35 U.S.C. §101.

With reference now to FIG. 3-A, there is shown a 3×3 grid of view identifiers of the nine respective component views of FIG. 3. Also FIG. 3-A depicts a call center 308 having one or more available human agents 394 employed by a service provider 398.

With reference now to FIG. 3-B, there is shown a medium 310 bearing one or more instances of evaluations 303, 304; of indications 305 of a negative reaction (to an expression of the second party, e.g.); of indications 306 of no detected reaction (to an expression of the second party, e.g.); or of indications 307 of a positive reaction (to an expression of the second party, e.g.). FIG. 3-B also depicts a party affiliate 392 (an entity who employs or otherwise concerns itself with what the second party does, e.g.).

With reference now to FIG. 3-C, there is shown components of a device 320 (used by or for the second party, e.g.) comprising one or more instances of cameras 201, microphones 202, sensors 203, or other characterization modules 205; of cues 211 (expressed digitally or audibly, e.g.); of feedback 212; of speakers 213, displays 214, or other presentation modules 215; or (auditory, electromagnetic, or other) emissions 221, 222, 223, 224, 225.

With reference now to FIG. 3-D, there is shown a party affiliate 291 of the “first” party 301 and a device 220 configure to observe the party (in a vicinity 209 of the party, e.g.). Device 220 may comprise a passenger vehicle occupied by (one or more individuals of) the party 301 in some variants. In others, device 220 may comprise a handheld or wearable device used by party 301. As described below, device 220 may include one or more instances of cameras 261, microphones 262, biometric or other sensors 263, or such other characterization modules 265 (recognition modules, e.g.); or of speakers 273, displays 274, or other presentation modules 275.

With reference now to FIG. 3-E, there is shown an interchange 250 configured to interact via one or more instance of linkage 251 (with party affiliate 291, e.g.), of linkage 252 (with party affiliate 392, e.g.), of linkage 253 (with a server 396 operated by service provider 390, e.g.), of linkage 254 (with device 220, e.g.), of linkage 255 (with entity 395, e.g.), of linkage 256 (with device 320, e.g.), of linkage 258 (with call center 308, e.g.). One or more such linkages 251-256, 258 may be configured for a wireless bidirectional communications, in some instances.

With reference now to FIG. 3-F, there is shown the “second” party 302 and a device 320 used by or for the second party. In some instances, device 320 may be an unmanned vehicle (programmed by party 302, e.g.). In others, device 320 may be a stationary security camera (configured to monitor a vicinity 309 of party 302, e.g.). In still others, device 320 may be a passenger vehicle occupied by party 302 or a targeted wearable communication device (glasses having a display 214 or an earpiece having a speaker 213 presented only to party 302, e.g.). Moreover in some contexts device 320 may be configured with a characterization module 205 (having one or more recognition modules as described herein, e.g.) configured to capture one or more expressions 381-385 (including an utterance 386 or other content 387, e.g.) of party 302. As described herein, many such manifestations 380 (of lewdness or other recordable attributes or behaviors, e.g.) may have a significant positive or negative value to first and second parties and their affiliates in a variety of contexts, and the automated selective inclusion or exclusion of such elements (components of expression 140, e.g.) from an archive or distillation will render feasible development of numerous additional patterns and protocols not explicitly set forth herein without any undue experimentation, even in instances of weakly or informally correlated indicia of harmfulness.

With reference now to FIG. 3-G, there is shown one or more expressions 281-285 (utterances 288 or other content 289, e.g.) manifested at the device used by or for the first party 301. Such manifestations 280 (wild gestures or angry facial expressions or other indicia of offendedness or other harm, e.g.) may include almost any patterns that coincide with emotional or other temporary impairment (clumsiness, high rates of errors and error corrections, slurred or other abnormal speech, slow response, profanity, e.g.) in some contexts. For at least this reason, a substantial fraction of implementations in which manifestations 380 of harmfulness may be characterized cost-effectively will be rendered accessible (by those skilled in the art who apply breakthrough data distillation techniques described herein, e.g.) after aggregation thereof (in an archive 397 at a server 396 owned by service provider 390, e.g.). In some contexts, for example, a systematic correlation with apparent manifestations 280 of harm (offendedness, e.g.) may be detected in corresponding instances of expression 170 (made by party 301, e.g.).

With reference now to FIG. 3-H, there is shown event-sequencing logic 350 (residing at interchange 250, e.g.) comprising one or more instances of personal behavior anomaly recognition modules 351, vehicle behavior anomaly recognition modules 352, clip capture modules 353, speech recognition modules 354, or other data distillation modules 355. In some contexts, moreover, event-sequencing logic 350 may further include one or more (instances of) intercommunications 361, 362, 363 (calls 357 or sessions 358 or dialogs 359, e.g.) or notification modules 371, 372, 373, 374, 375, 376, 377, 378 as further described below.

With reference now to FIG. 3-I, there is shown data-handling medium 330, one or more instances of which are implemented (in a server or satellite, e.g.) at the interchange 250. Each such instance may include one or more instances of intervals 311, 312, 313; of clips 315 (generated by clip capture module 353, e.g.); of images 316 (received from one or more cameras 201, 261 of FIG. 3 and depicting one or more of the parties, for example); of descriptions 317, 318, 319; of identifications 321, 322, 323, 324; or of other such components 325, 326, 327, 328, 329.

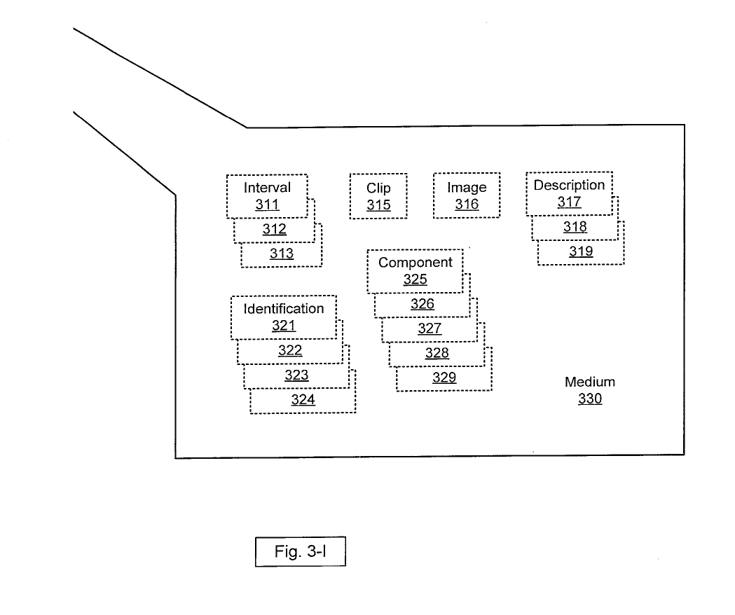

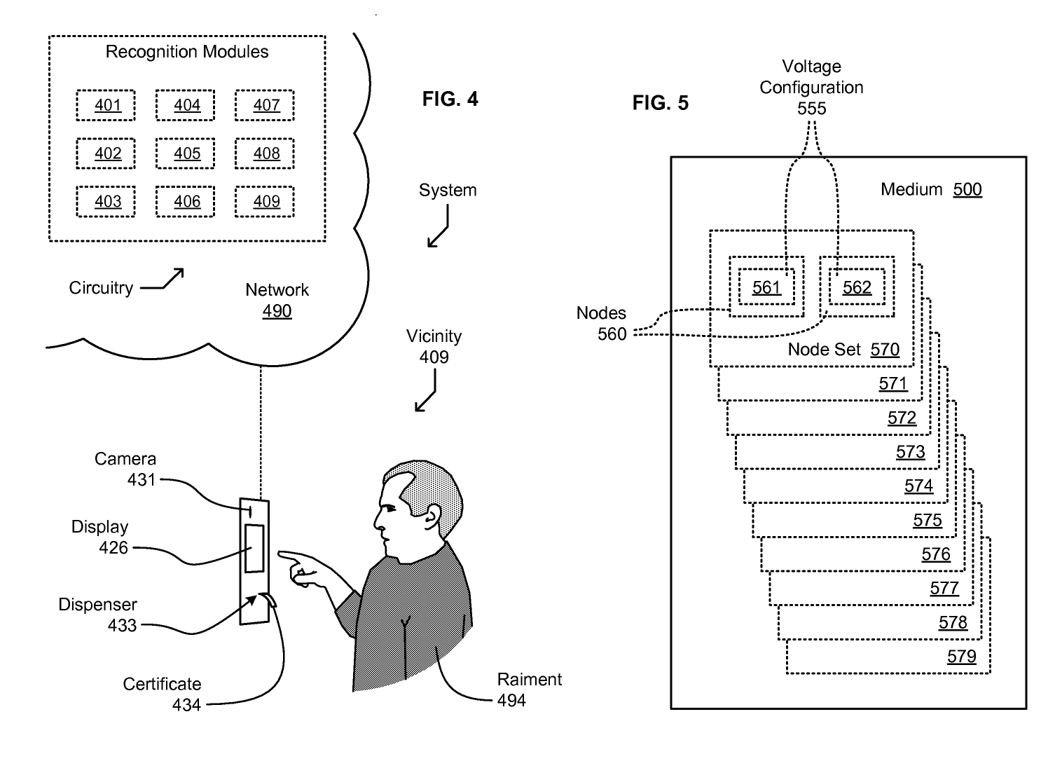

With reference now to FIG. 4, a system is shown in schematic form comprising one or more instances of recognition modules 401, 402, 403, 404, 405, 406, 407, 408, 409 residing in a network 490 (in an application programmer interface of a device described herein, e.g.) operably coupled with a kiosk in a vicinity 409 of a party. The kiosk comprises a display 426, a camera 431, and a dispenser 433 by which the party can receive one or more dispensed articles (a certificate 434, e.g.). This can occur, for example, in a context in which the party can be identified or otherwise characterized (by one or more of the recognition modules 401-409 recognizing the party's raiment 494, e.g.); in which the party can provide user input (by pushing buttons or making verbal or facial expressions or gestures, e.g.); and in which such recognition module(s) 401-409 of network 490 reside in aggregator 193 or at interchange 250.

With reference now to FIG. 5, a system is shown in schematic form comprising one or more instances of data-handling media 500 (random-access memory 236 on an integrated circuit chip 240, e.g.) comprising many node sets 570, 571, 572, 573, 574, 575, 576, 577, 578, 579 each comprising one or more nodes 560 each having a corresponding voltage 561, 562. A voltage configuration 555 of each node set comprises a “high” or “low” voltage 561 at each respective node of the node set.

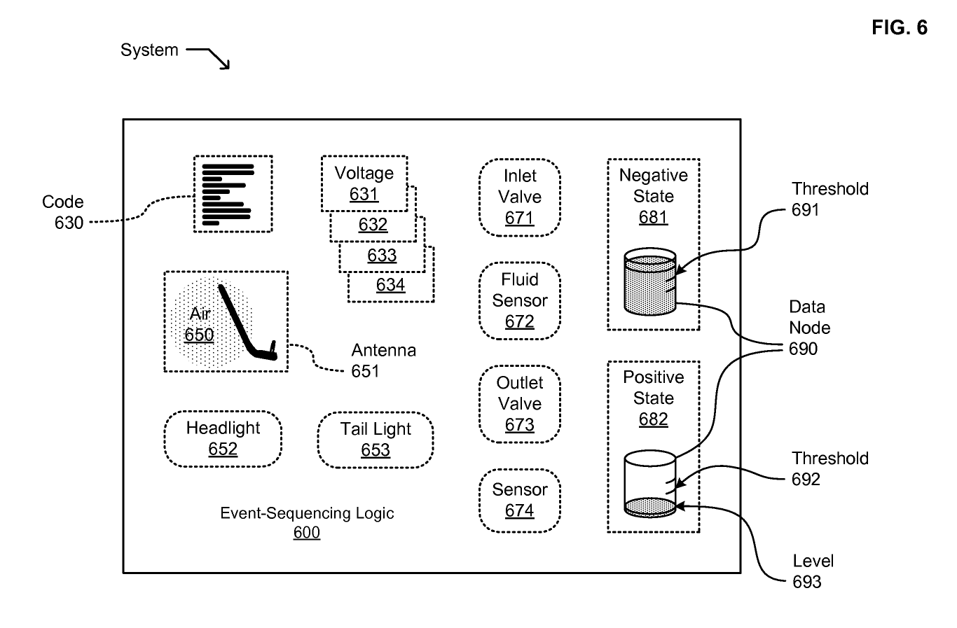

With reference now to FIG. 6, a system is shown comprising event-sequencing logic 600 that includes one or more tangible data-handling media 500 (holding processor-executable code 630 manifested as respective voltages 631, 632, 633, 634, e.g.). Event-sequencing logic 600 may likewise include one or more instances of antennas 651, headlights 652, tail lights 653, or other such transmission media configured to transmit digital data wirelessly (via one or more linkages 251-256 through air 650 as described above, e.g.). Alternatively or additionally, such digital data may likewise be manifested as data nodes 690 each literally containing a fluid, for example, so that voltage-like levels signify either a negative state 681 (as any fluid level 693 above a threshold 691, e.g.) or a positive state 682 (as any fluid level 693 below a threshold 692, e.g.). A fluid inlet valve 671 may allow fluid to enter (as a “current,” e.g.) so that data node 690 transitions from positive state 682 to negative state 681. Conversely a fluid outlet valve 673 may allow fluid to exit so that data node 690 transitions from negative state 681 to positive state 682. In some contexts, for example, one or more instances of fluid sensors 672 may be configured to detect a fluid level configuration of or transitions in a data node set manifesting one or more indications (decisions, e.g.) as described below. Transistor components or other sensors 674 can likewise manifest such indications (measurements, e.g.) in some variants, as further described below.

FIG. 7 depicts an exemplary environment in which one or more technologies may be implemented, a system including a primary unit 710 (residing in one or more instances of devices 120, 220, 320 describe herein, e.g.) operably coupled with a stationary secondary unit 760 (implemented as a wall-mounted device 775 or kiosk, e.g.). The primary unit 710 as shown comprises one or more instances of decision modules 721, 722, 723, 724, 725, 726, 727, 728, 729 (configured to generate decisions 741, 742, 743, 744, 745, 746, 747, 748, 749 as described below, e.g.) and decision determinants (such as a table 740 comprising several records 714, 715, 716 each mapping one or more identifiers 702, 703 to a corresponding index 701, e.g.). The secondary unit 760 as shown comprises one or more instances of text strings 781 or other digital values 782 usable by one or more invocation modules 791, 792, 793, 794, 795, 796, 797, 798 as described below (implemented in special-purpose circuitry, e.g.).

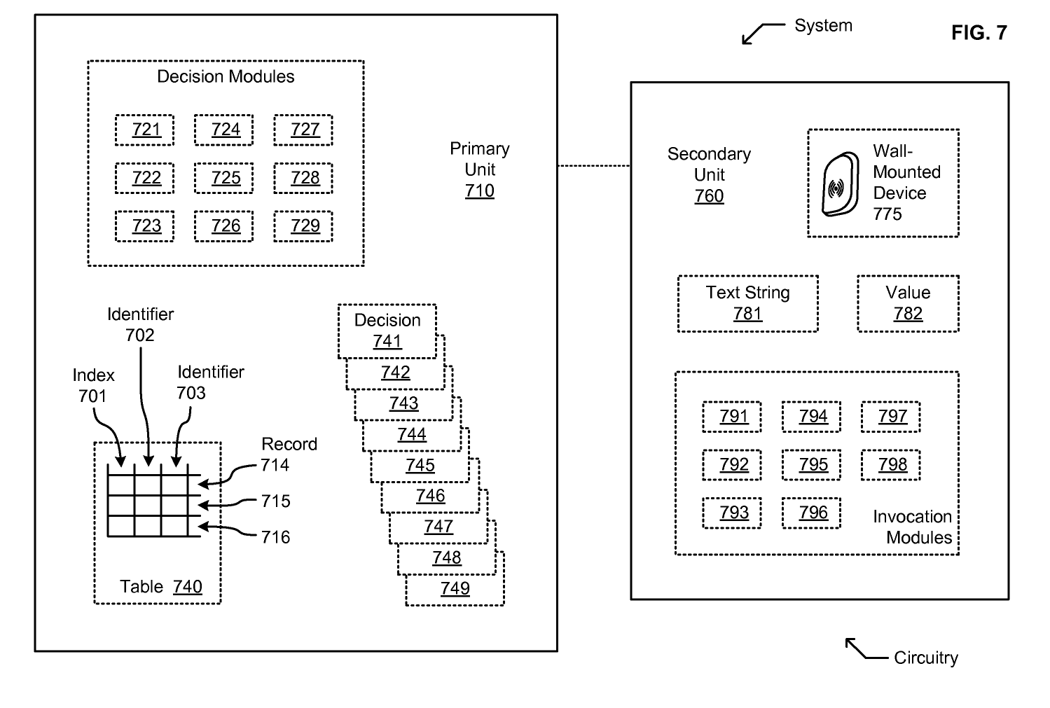

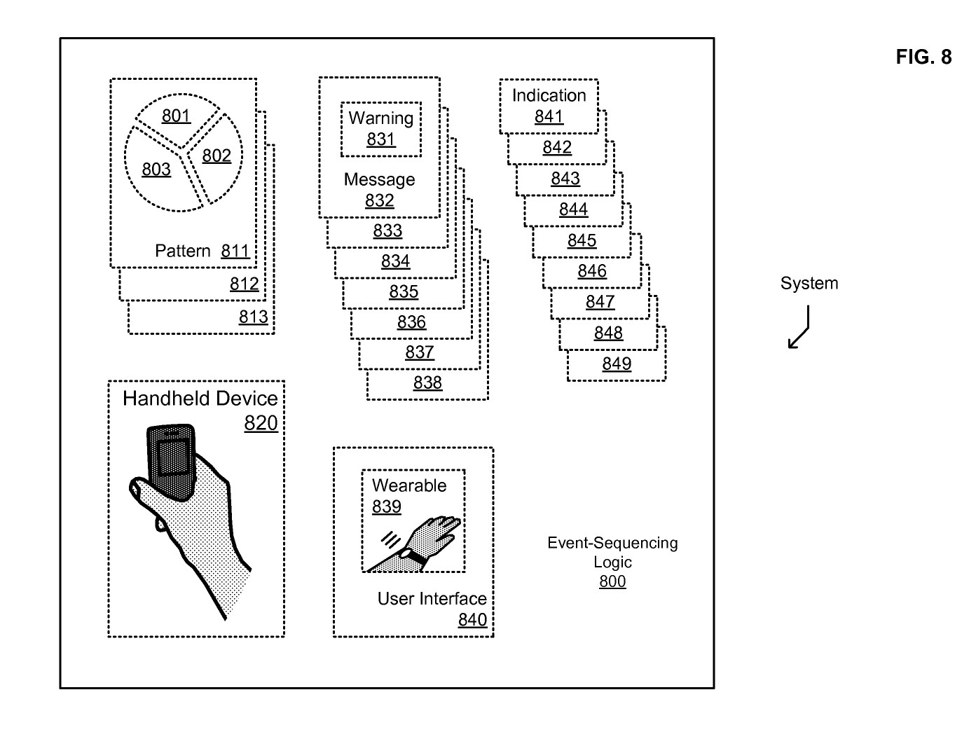

FIG. 8 depicts an exemplary environment in which one or more technologies may be implemented, a system including a schematic depiction of event-sequencing logic 800. Such logic may reside in a handheld device 820 or wearable 839 or other user interface 840 and may (optionally) include one or more instances of data patterns 811, 812, 813 (each having one or more components 801, 802, 803, e.g.); of warnings 831 or other messages 832, 833, 834, 835, 836, 837, 838; or of indications 841, 842, 843, 844, 845, 846, 847, 848, 849.

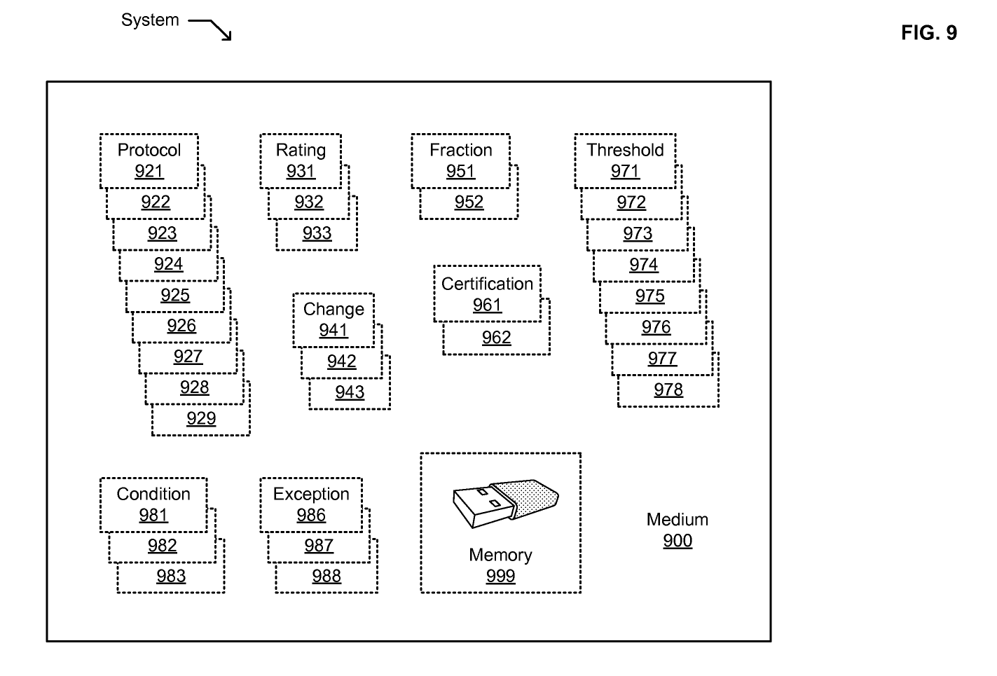

FIG. 9 depicts an exemplary environment in which one or more technologies may be implemented, including a schematic depiction of a data handling medium 900. In some variants, medium 900 may include one or more instances of protocols 921, 922, 923, 924, 925, 926, 927, 928, 929; of ratings 931, 932, 933; of changes 941, 942, 943; of fractions 951, 952; of certifications 961, 962; of thresholds 971, 972, 973, 974, 975, 976, 977, 978; of conditions 981, 982, 983; or of exceptions 986, 987, 988 expressed digitally. This can occur, for example, in a context in which one or more instances of event-sequencing logic 600, 800 or data-handling media 500, 900 (as removable memory 999, e.g.) reside in primary unit 710.

Several variants described herein refer to device-detectable “implementations” such as one or more instances of computer-readable code, transistor or latch connectivity layouts or other geometric expressions of logical elements, firmware or software expressions of transfer functions implementing computational specifications, digital expressions of truth tables, or the like. Such instances can, in some implementations, include source code or other human-readable portions. Alternatively or additionally, functions of implementations described herein may constitute one or more device-detectable outputs such as decisions, manifestations, side effects, results, coding or other expressions, displayable images, data files, data associations, statistical correlations, streaming signals, intensity levels, frequencies or other measurable attributes, packets or other encoded expressions, or the like from invoking or monitoring the implementation as described herein.

In some embodiments, a “state” of a component may comprise “available” or some other such state-descriptive labels, an event count or other such memory values, a partial depletion or other such physical property of a supply device, a voltage, or any other such conditions or attributes that may change between two or more possible values irrespective of device location. Such states may be received directly as a measurement or other detection, in some variants, and/or may be inferred from a component's behavior over time. A distributed or other composite system may comprise vector-valued device states, moreover, which may affect dispensations or departures in various ways as exemplified herein.

“After,” “automatic,” “among,” “anonymous,” “apparently,” “as,” “arranged,” “associated,” “audible,” “caused,” “between,” “bidirectional,” “common,” “component,” “conditional,” “configured,” “constructed,” “coupled,” “defined,” “detectable,” “determined,” “executable,” “executed,” “free,” “from,” “effective,” “handheld,” “indirect,” “informational,” “in a vicinity,” “local,” “later,” “mobile,” “more,” “implemented,” “in association with,” “integrated,” “interpersonal,” “only,” “operable,” “portable,” “single,” “particular,” “nominal,” “within,” “passive,” “partly based,” “previously,” “proactively,” “programmatic,” “received,” “remote,” “responsive,” “signal-bearing,” “switched,” “resident,” “selective,” “shared,” “specific,” “special-purpose,” “stationary,” “temporary,” “matching,” “significant,” “semi-permanent,” “transitory,” “transmitted,” “virtual,” “visible,” “wireless,” or other such descriptors herein are used in their normal yes-or-no sense, not as terms of degree, unless context dictates otherwise. In light of the present disclosure those skilled in the art will understand from context what is meant by “vicinity,” by being “in” a region or “within” a range, by “remote,” and by other such positional descriptors used herein. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. As used herein, the term “tangible medium” does not definitionally encompass mere transitory propagating signals. “For” is not used to articulate a mere intended purpose in phrases like “circuitry for” or “instruction for,” moreover, but is used normally, in descriptively identifying special purpose software or structures.

In some embodiments a “manual” occurrence includes, but is not limited to, one that results from one or more actions consciously taken by a device user in real time. Conversely an “automatic” occurrence is not affected by any action consciously taken by a device user in real time except where context dictates otherwise.

In some embodiments, “signaling” something can include identifying, contacting, requesting, selecting, or indicating the thing. In some cases a signaled thing is susceptible to fewer than all of these aspects, of course, such as a task definition that cannot be “contacted.”

In some embodiments, “causing” events can include triggering, producing or otherwise directly or indirectly bringing the events to pass. This can include causing the events remotely, concurrently, partially, or otherwise as a “cause in fact,” whether or not a more immediate cause also exists.

As used herein, a static value (phone number or other entity identifier, e.g.) cannot be “derived from” another static value if both are the same. Likewise a component that merely relays an input signal as an output signal does not “derive” the output signal. In light of teachings herein, however, numerous existing techniques may be applied for configuring special-purpose circuitry or other structures effective for implementing a time-varying or other quantitative modulations as described herein without undue experimentation.

Some descriptions herein refer to an “indication whether” an event has occurred. An indication is “positive” if it indicates that the event has occurred, irrespective of its numerical sign or lack thereof. Whether positive or negative, such indications may be weak (i.e. slightly probative), definitive, or many levels in between. In some cases the “indication” may include a portion that is indeterminate, such as an irrelevant portion of a useful photograph.

Some descriptions herein refer to a “device” or other physical article. A physical “article” described herein may be a long fiber, a transistor 271, a submarine, or any other such contiguous physical object. An “article” may likewise be a portion of a device as described herein (part of a memory 237 or antenna 651 of a smartphone, e.g.) or a mechanically coupled grouping of devices (a tablet computer with a removable memory and earpiece attached, e.g.) as described herein, except where context dictates otherwise. A communication “linkage” may refer to a unidirectional or bidirectional signal path via one or more articles (antennas or other signal-bearing conduit, e.g.) except where context dictates otherwise. Such linkages may, in some contexts, pass through a free space medium (air 650, e.g.) or a network 490.

Referring again to FIGS. 1-3, a system 300 may comprise an electrical node set upon which a voltage configuration signifies an identification 322 of an individual (a plurality of nodes 243 each having a value of one or zero collectively embodying a text string or other digital value 782 identifying one or more clients or other parties 101, 102, 301, 302 as described herein, e.g.) or circuitry (including numerous instances of transistors 272, e.g.) configured to obtain such identification (as user input or other sensor input, e.g.). The system also comprises another node set (one or more other electrical nodes 241, e.g.) upon which a voltage configuration conditionally manifests a decision 745 whether or not to invoke one or more protocols 921-925 (executable or otherwise invocable by a processor, e.g.) as an automatic and conditional response partly based on the identification 322 of the individual and partly based on an indication of a “first” one of the individuals or parties not reacting positively (an indication 305 of party 101 or party 301 reacting negatively, e.g.) to a communicative expression of a “second” one of the individuals or parties (following a microaggression or similar expression 140 by party 102 or party 302 that is of interest and is potentially detectable by a person who observes the expression in a video or audio clip 315 or image 316, e.g.). As further described below, such phenomena may or may not be device detectable ab initio, in respective embodiments. Such triggering expressions 140 (microaggressions, e.g.) are readily device detectable in some contexts; or are at least detectable by people (who review an archive, e.g.) cost-effectively with the aid of data distillation or other intelligence amplification as described herein; or are particularly insidious and subtle (detectable only by a few people, e.g.) in still other contexts, as described herein.

Some variants may (optionally) include a protocol 921 comprising a special-purpose decision module 721 invocable for generating a decision 741 whether or not to discard a first recorded data component 325 of a communicative expression of the “second” individual (in a context in which such data would otherwise be stored indefinitely in an archive 397, e.g.). This can occur, for example, in a context in which the “second” individual (party 302, e.g.) made a series of potentially offensive gestures, utterances 386, or other expressions 381-385 that were captured by a camera 201, microphone 202, or other such characterization module; in which primary unit 710 and medium 900 reside in interchange 250 and in which a person manually or otherwise processing one or more other components 326-329 of the recorded data (in developing or refining decision modules 721-729 as described herein, e.g.) would otherwise be cost-prohibitive.

Alternatively or additionally, some variants may include a protocol 922 comprising a special-purpose decision module 722 invocable for generating a decision 742 whether or not to establish or otherwise facilitate an intercommunication 361 to or with another entity (a call 357 or other session 358 with a live agent 394 or a party affiliate 291, 392 or other third party, e.g.) in response to suitable determinants (responsive to one or more event sequences each comprising an utterance 288 or other expression 281-285 and collectively deemed to signify anxiety or other personal impairment as described herein, e.g.). This can occur, for example, in a context in which the “third” party (an employer or other party affiliate 392 of the “second” party 302, e.g.) is proactively concerned with the “first” party's experience (being trouble free, e.g.) or in which the “first” party is apparently agitated (according to one or more real-time biometrics, e.g.) already; in which the other entity has special training (in acculturation to one or more attributes of the first party, e.g.); and in which the automatic establishment of such specialized third-party involvement (having a vice-president participating in every single client visit, e.g.) would otherwise be cost-prohibitive.

Alternatively or additionally, some variants may include a protocol 923 comprising a special-purpose decision module 723 invocable for generating a decision 743 whether or not to adjust one or more performance evaluations 303 of the “second” individual. This can occur, for example, in a context in which such performance ratings 931-933 or other evaluations 303, 304 periodically improve (by 0.1 points each hour or day, e.g.) in the absence of a “first” individual (party 301, e.g.) reacting negatively; in which only a particular set of indications 305 (deemed highly reliable by an expert, e.g.) of a negative reaction trigger a downward adjustment; in which such performance evaluations affect one or more privileges of the “second” individual (to receive another client or to receive a bonus, e.g.); and in which such useful indicia of the second party's authentic effectiveness (in regard to heterogeneous interactions, e.g.) would otherwise require enticing numerous parties (clients, e.g.) each to participate in an irritating satisfaction survey. In some variants, moreover one or more components of content 387 (phrases or shapes presented via presentation module 275, e.g.) may likewise have various performance ratings 931-933 or other evaluations 303, 304 affected as a function of the “first” individual (or numerous individuals) reacting positively or not to such content (manifested in one or more expression 381-385 that they can perceive, e.g.).

Alternatively or additionally, some variants may include a protocol 924 comprising a special-purpose decision module 724 invocable for generating a decision 744 whether or not to signal a disruptive emission 221-225 in a vicinity 109, 309 of the “second” individual. This can occur, for example, in a context in which indications of the “first” individual not reacting positively have been established by (respective instances of) a personal behavior anomaly recognition module 351 configured to detect negative expressions 170 or indicia of present impairment (relative to a norms of the “first” individual or a population cohort to which the individual belongs, e.g.) suitable for linkage with respective responsive protocols presented below; and in which mitigating the harmful actions (verbal or other expressions by the second individual, e.g.) might not otherwise be feasible.

Alternatively or additionally, some variants may include a protocol 925 comprising a special-purpose decision module 725 invocable for manifesting one or more decisions 741-749 with a corresponding expression 381-385 in a vicinity 409 of a third individual. This can occur, for example, in a context in which a manifestation of growing approval is presented (simultaneously with content to which such approval relates, e.g.) as a real-time response to (several instances of) the “first” individual (in a collaborative authoring context, e.g.) responding positively and in which a manifestation of shrinking approval (a decreasing percentage or graphically displayed fraction 952, e.g.) is presented as a real-time response (within at most an hour thereof, e.g.) to the “first” individual not responding positively (via a display 426 or certificate 434 in a vicinity 409 of the third individual, e.g.).

In light of teachings herein, numerous existing techniques may be applied for implementing automatic recognition of human expressions and attributes as described herein without undue experimentation. See, e.g., U.S. Pat. No. 8,810,624 (“Apparatus and method for configuring screen for video call using facial expression”); U.S. Pat. No. 8,780,221 (“Facial expression recognition apparatus, image sensing apparatus, facial expression recognition method, and computer-readable storage medium”); U.S. Pat. No. 8,760,551 (“Systems and methods for image capturing based on user interest”); U.S. Pat. No. 8,751,957 (“Method and apparatus for obtaining auditory and gestural feedback in a recommendation system”); U.S. Pat. No. 8,744,691 (“Adaptive human-machine system and method”); U.S. Pat. No. 8,719,015 (“Dialogue system and method for responding to multimodal input using calculated situation adaptability”); U.S. Pat. No. 8,692,940 (“Method for producing a blended video sequence”); U.S. Pat. No. 8,667,519 (“Automatic passive and anonymous feedback system”); U.S. Pat. No. 8,644,599 (“Method and apparatus for spawning specialist belief propagation networks”); U.S. Pat. No. 8,640,959 (“Acquisition of a user expression and a context of the expression”); U.S. Pat. No. 8,630,493 (“Techniques for enabling or establishing the use of face recognition algorithms”); U.S. Pat. No. 8,629,895 (“Camera-based facial recognition or other single/multiparty presence detection as a method of effecting telecom device alerting”); U.S. Pat. No. 8,598,980 (“Biometrics with mental/physical state determination methods and systems”); U.S. Pat. No. 8,593,523 (“Method and apparatus for capturing facial expressions”); U.S. Pat. No. 8,581,930 (“Method for automatically producing video cartoon with superimposed faces from cartoon template”); U.S. Pat. No. 8,532,347 (“Generation and usage of attractiveness scores”); U.S. Pat. No. 8,514,251 (“Enhanced character input using recognized gestures”); U.S. Pat. No. 8,488,023 (“Identifying facial expressions in acquired digital images”); U.S. Pat. No. 8,467,599 (“Method and apparatus for confusion learning”); U.S. Pat. No. 8,392,183 (“Character-based automated media summarization”); U.S. Pat. No. 8,373,799 (“Visual effects for video calls”); U.S. Pat. No. 8,370,145 (“Device for extracting keywords in a conversation”); U.S. Pat. No. 8,341,109 (“Method and system using a processor for reasoning optimized service of ubiquitous system using context information and emotion awareness”); U.S. Pat. No. 8,290,604 (“Audience-condition based media selection”); U.S. Pat. No. 8,219,438 (“Method and system for measuring shopper response to products based on behavior and facial expression”); U.S. Pat. No. 8,209,182 (“Emotion recognition system”); U.S. Pat. No. 8,203,530 (“Method of controlling virtual object by user's figure or finger motion for electronic device”); U.S. Pat. No. 8,194,924 (“Camera based sensing in handheld, mobile, gaming or other devices”); U.S. Pat. No. 8,112,371 (“Systems and methods for generalized motion recognition”); U.S. Pat. No. 8,094,891 (“Generating music playlist based on facial expression”); U.S. Pat. No. 8,010,402 (“Method for augmenting transaction data with visually extracted demographics of people using computer vision”).

Alternatively or additionally, system 300 may comprise an electrical node set 570 upon which (an instance of) a voltage configuration 555 (having respective states of “LL” or “LH” or “HL” or “HH”, in some variants) manifests an identification 323 of a “first” motor vehicle (implementing device 220, e.g.) or of a “second” motor vehicle (implementing device 320, e.g.) or circuitry (including transistors 271, e.g.) configured to obtain such identification. Such identification can include a license plate or other alphanumeric text string 781, for example. The system further comprises a node set 573 upon which a voltage configuration conditionally manifests a decision 745 whether or not to invoke one or more protocols 925-929 as an automatic and conditional response partly based on the vehicle identification 323 and partly based on an indication 849 of an occupant of the “first” motor vehicle (party 301, e.g.) not reacting positively to an action of the “second” motor vehicle (a recorded and potentially detectable data component manifesting an emission or movement of device 320, e.g.) and otherwise as described herein. In some contexts, for example, an indication 306 of no reaction having been detected (by one or more recognition modules 401-409 configured to perform such selective detection, e.g.) constitutes such an indication 849. Moreover in a context in which the occupant is a driver or pilot of the “first” motor vehicle, in some contexts an indication 849 of “not reacting positively” may be established by (respective instances of) a vehicle behavior anomaly recognition module 352 configured to detect legal infractions (speeding, e.g.), impermissible positioning (following too closely or having been abandoned in a restricted area, e.g.), erratic vehicle movement (an abnormal number of lane corrections, e.g.), or other such anomalous vehicular data (relative to a norms of a particular vehicle or of a fleet of similar vehicles, e.g.).

Protocol 926 may include, for example, invoking a special-purpose decision module 726 invocable for generating a decision 746 whether or not to discard a recorded data component 326 pertaining to the “second” motor vehicle. In some variants, protocol 927 may likewise include a special-purpose decision module 727 invocable for generating a decision 747 whether or not to establish or otherwise facilitate an intercommunication 362 to or with another entity (to or with a party affiliate 291, 392 or other third party or device, e.g.). In some variants, protocol 928 may likewise include a special-purpose decision module 728 invocable for generating a decision 748 whether or not to adjust one or more performance evaluations 304 of an individual (identified as a driver of the “second” vehicle, e.g.). In some variants, protocol 929 may likewise include a special-purpose decision module 729 invocable for generating a decision 749 whether or not to signal a disruptive emission 221-225 as described herein.

In light of teachings herein, one skilled in the art will recognize variants of the above embodiments in which a first party 301 receives a wireless communication device 220 (owned by party affiliate 392, e.g.) from a second party 302 (a clerk, e.g.) or automatic dispenser upon arrival into a waiting area (implementing a lobby or queue, e.g.). The device 220 includes a first notification module 371 configured to present a message 837 signaling when a resource (a requested space or service, e.g.) becomes available. The device 220 also includes a second notification module 372 configured to present a message 838 signaling an automatic and conditional eligibility for or dispensation of a compensatory concession (a notification that “the order you have just placed is free today” for a wait that exceeds a threshold 977 of more than five minutes or less than thirty minutes, e.g.). In some variants, moreover, one or more exceptions 986-988 may effectively enable notification module 372 even before threshold 977 is exceeded. One such exception 987 may result, for example, from an indication 847 (from a recognition module 408, e.g.) of the first party having manifested impatience (by looking repeatedly at a wall-mounted clock in a vicinity 209 thereof (the waiting area, e.g.) or some other device-detectable response (an attribute that is observable and potentially attributable to slow service or some other expression 384 of negligence, e.g.) that is not positive. Alternatively or additionally, one or more conditions 981-983 (such as receiving an indication 848 that a manager of the establishment has authorized such compensation, e.g.) may effectively control the operation of notification module 372. This can occur, for example, in a context in which such substantial concessions would not otherwise safeguard the establishment's reputation in a cost-effective manner (by implementing unnecessary disbursements or fostering a perception that the manager was administering the policy arbitrarily, e.g.).

In light of teachings herein, one skilled in the art will likewise recognize variants of the above embodiments in which event-sequencing logic 800 includes an electrical node set 575 upon which a voltage configuration conditionally manifests (an occurrence of) an indication 844 (generated via one or more invocation modules 791-798 or recognition modules 401-409 thereof, e.g.) signifying more than an a priori threshold 975 (of at least 2% or at most 20%, e.g.) of a monitored sample of a broadcast audience (viewers or listeners observing a debate or interview, e.g.) ending their monitoring within a given interval 311 (of more than 3 or less than 30 seconds, e.g.). This can occur, for example, in a context in which a party 302 is under scrutiny (by a sponsor or other party affiliate 392, e.g.); and in which invocation module 792 is configured to respond in real time to such indication 844 automatically and conditionally, such as by signaling a disruptive emission 223 (signal static in a vicinity 109, 309 of a cohort of the audience, e.g.). In some contexts, for example, such an emission may comprise an intervening message 836 (“we interrupt this broadcast, e.g.). Alternatively or additionally, one or more other such modules described herein may be configured to respond to such indication 844 (an invocation module 793 that adjusts a performance evaluation 303 of the speaker incrementally downward, e.g.) automatically and conditionally as described herein, optionally manifesting the evaluation 303 or an occurrence of an adjustment (as a “beep” or flash or performance bar size change 941, e.g.) discreetly presented to the party (via a presentation module 215 worn by the party, e.g.) in real time.

In light of teachings herein, one skilled in the art will likewise recognize variants of the above embodiments in which (a data-handling medium of) event-sequencing logic 800 includes an electrical node set 571 upon which a voltage configuration conditionally manifests an indication 845 (generated via one or more invocation modules 791-798 or recognition modules 401-409 thereof, e.g.) signifying more than a given threshold 976 (of at least 1% or at most 5%, e.g.) of a monitored subset of an in-person audience (in which there are multiple instances of a party 301 who are attending a speech of another party 302, e.g.) manifesting a recognizable negative response (signaling anger or sadness or disgust, e.g.) or otherwise not manifesting a positive response (failing to smile or laugh or pay attention contemporaneously with several others in attendance doing so, e.g.) simultaneously or within a given interval 312 (of 1 or 10 seconds, e.g.). This can occur, for example, in a context in which some of their apparent emotional states can be recorded (in a photo or clip via a camera 261 or other characterization module 265 in their vicinity 209, e.g.) and selectively detected via one or more recognition modules 401 (within the module or operably coupled therewith, e.g.). This can occur, for example, in a context in which invocation module 795 is configured to respond to such indication 845 automatically and conditionally, such as by instantiating an intercommunication 363 (a real-time status update or dialog 359, e.g.) to or with a third party (a public relations agent 394 or other entity 191 other than the speaker or audience, e.g.). Alternatively or additionally, one or more other invocation modules 791-798 described herein may be configured to respond to such indication 845 automatically and conditionally as described herein (an invocation module 796 that selectively discards a recorded data component 801 of a communicative expression of the party 302 who is speaking while retaining another recorded data component 802 thereof, e.g.).

In light of teachings herein, one skilled in the art will likewise recognize variants of the above embodiments in which one or more media 310, 330 include (an instance of) an electrical node set 574 upon which a voltage configuration manifests a pattern 811 (recognized by speech recognition module 403, e.g.) manifesting a verbal expression 382 identified a priori as offensive (an utterance 386 of “can you afford that?” or “your kind” spoken by a party 102 recognized as a sales associate of a retail entity 192, e.g.) or a verbal expression 383 matching a pattern 812 associated with offendedness (in which an utterance 288 or other component comprises a recitation of “racist” or “the manager” or an expletive spoken by a party 101 not recognized as a sales associate of the retail entity, e.g.) or similar impairment. This can occur, for example, in a context in which such sales associates all have device-recognizable faces or all wear device-recognizable items (a uniform or other raiment 494 selectively detectable by recognition module 404, e.g.). Alternatively or additionally, one or more patterns may (optionally) be configured to match a communicative expression 285 only when it features one or more of a significant inter-expression delay (an interval 313 between respective arrivals of a component 327 of expression 140 and a component of expression 170 measured as being greater than a duration threshold 971 of 0.5 to 2.5 seconds, e.g.) or a minimum volume (being greater than a volume threshold 972 of 75 to 95 decibels, e.g.) or a brisk movement (moving faster than a pedestrian's speed threshold 973 of 2 to 6 miles per hour, e.g.) or other such circumstantial components of expressive content 289 (detectable by recognition module 402, e.g.) defined by a technician (a research assistant, e.g.). A great variety of such thresholds 971-978 and patterns 811-813 and recognition modules 401-409 can be developed cost-effectively in light of teachings herein without any undue experimentation (through device-facilitated data distillation described herein and refinements therefrom, e.g.). In some variants, for example, an authorized entity (an expert or expert system, e.g.) may have specified such expressions or thresholds or other parameters after having correlated one or more of them with giving offense or having taken offense (based upon appropriate data distillations, e.g.) in a given context (a retail or vehicle-related or conversational milieu, e.g.) as described herein.

In light of teachings herein, one skilled in the art will likewise recognize variants of the above embodiments in which one or more media 310, 330 (residing in one or more devices 120, 220, 320 described herein or along a signal path therebetween, e.g.) include an electrical node set 576 upon which a voltage configuration 555 manifests an indication 841 signifying that only innocuous (lacking an indication 305 of party 301 reacting negatively from one or more recognition modules 407, e.g.) or insignificant (coinciding with a fraction 951 of device-detectable audience members smaller than a particular threshold 974 exhibiting a device-detectable transition each to a respective facial expression 282 or other biometric indication 843 recognized by recognition module 407 as matching a pattern 813 signifying an emotional state strong enough to be manifested by a device-detectable biometric profile, e.g.) expressions were apparently present.

In light of teachings herein, one skilled in the art will likewise recognize variants of the above embodiments in which party 302 wears or carries a device 320 (owned by party affiliate 392, e.g.) that includes one or more notification modules 371-378 as described herein. One such notification module 374, for example, is configured to mirror (via a presentation module observable by party 302, e.g.) any notification sent to a device 220 worn or held by a client (party 301, e.g.) as described herein. Alternatively or additionally, device 320 may include a notification module 375 configured to trigger a cue 211 (a “standby” tone or flashing light, e.g.) perceptible to party 302 selectively (being neither visible or audible to party 301, e.g.) as an automatic and conditional response to a computed frequency (an occurrence count within a given time interval, e.g.) of apparently negative indications 841-849 of interactions (provided by a recognition module 409 configured to detect occurrences of party 302 interrupting party 301 or of either party interrupting the other, e.g.) exceeding an effective threshold 978 (corresponding to a frequency of conversational interruptions that is greater than once per minute or less than once per hour, e.g.).

In light of teachings herein, one skilled in the art will likewise recognize variants of the above embodiments in which a passenger vehicle (instantiating device 220, e.g.) includes or otherwise interacts with a special purpose notification module 373 configured to broadcast a warning 831 or other substantive message 832 associating a particular entity (comprising identifications 321-324 of one or more parties or affiliates or a respective device thereof, e.g.) with a corresponding description 317 (a categorization of the entity comprising a text string of “dangerous or “unknown” or a performance evaluation 303, e.g.). Such transmitted messages can, for example, be implemented as a wireless transmission (via a signal modulation in an antenna 651 or headlight 652 or tail light 653 operably coupled with device 220, e.g.) that is humanly imperceptible (in a radio frequency transmission or modulated visible light communication, e.g.). In some contexts, moreover, such a broadcast may be relayed through a succession of vehicles or similar ad hoc network configuration. Alternatively or additionally, such notification may be transmitted selectively to nearby devices (as a locally targeted commercial message 835 like “you are invited to receive a $10 credit directly to your Visa® or Paypal® account if you will complete our secure 5-minute survey,” e.g.).

In light of teachings herein, one skilled in the art will likewise recognize variants of the above embodiments in which a passenger vehicle (operated by party 101, e.g.) is preparing to approach a point of sale or related location (at a menu station that is used to define transactions that are then completed at a drive through window, e.g.) and shortly thereafter intones an irritated vocalization (loudly saying “just wait!” a similar expression, e.g.) right after an employee says something (through a speaker at the menu station, e.g.) detected by recognition module 405. A variety of expressions in such contexts may selectively indicate a reaction (to the employee's expression, e.g.) that is not positive without undue experimentation.

In light of teachings herein, one skilled in the art will likewise recognize variants of the above embodiments in which one or more media 310, 330 include an electrical node set 579 upon which a voltage configuration manifests an indication 846 signifying a context in which an entity 192 has an association 182 with one or more parties 102, 302 (employees or clients thereof, e.g.) manifested by an instance of device 320 (worn or carried by each such party, e.g.) and by respective records in which a respective (instance of) record 715 uniquely links a respective (instance of) device identifier 702 with a respective (instance of) identifier 703 of such party. In a point of sale context, for example, device 320 may be associated with party 302 or with entity 192 in this fashion. Likewise in a vehicular context, a record 714 may uniquely link a device identifier 702 (a Vehicle Identification Number or license plate, e.g.) with an identifier 703 of such party (a personal or corporate name or employee number, e.g.).

In light of teachings herein, one skilled in the art will also recognize variants of the above embodiments in which a sales associate (an employee of entity 192, e.g.) speaking too soon (within a time interval less than a threshold of 0.5 to 5 seconds as detected by recognition module 405, e.g.) after a visitor's arrival at a point of sale or related location is detected by recognition module 406, which then generates a digital indication 842 of such negative response (manifested as a conditional lack of an indication 307 of a positive reaction, e.g.). This can occur, for example, in a context in which one or more decision modules 721-729 are configured to respond to such an indication of impatience or a negative reaction thereafter by an appropriate disruptive emission 221 (a superseding message 833 like “please take your time, you may order when ready” visibly or audibly presented to a customer via a speaker 273 or display 274, e.g.). Alternatively or additionally such a message 833 may be presented to the associated entity (party 102, e.g.) whose behavior is of interest. In some contexts in which a questionable utterance is apparently being made in an immediate vicinity 309 of both an associate and customer, moreover, a disruptive emission 222 (via a speaker of device 120, e.g.) may implement noise cancellation or a suitable distraction (a nearby phone ringing, e.g.) effective to mitigate such behavior. A variety of such event sequences in such contexts effectively indicate a device-detectable reaction that is not positive (established by an empirical correlation of negative transaction outcomes or customer remarks, e.g.) without undue experimentation.

In some variants, moreover, one or more decision modules described herein may respond to one or more device-detectable criteria described herein by awarding a compensation (by vending a certificate 434 saying “good for 20% off a future purchase” or similar prize directly to such party, e.g.). Alternatively or additionally, in a context of an abusive customer or one that might best be mitigated by providing timely coaching to a sales associate (one who has been identified as having a particular certification 961 (signifying authority, e.g.) or higher-than-average performance rating 932 relative to other sales associates, e.g.), one or more invocation modules 791-798 may (optionally) be configured to trigger a message 834 privately directed to such associate (to an earphone or other presentation module 215 perceptible to the sales associate but not perceptible to an apparently abusive customer, e.g.) in real time, conditionally as described herein. Such messages may include components of encouragement (like “we love you Donald, hang in there!” e.g.) or other useful guidance (like “no matter who is right, the best tactic might be to apologize to this particular customer,” e.g.). In some contexts, for example, a variety of such performance ratings 931-933 (each on an A-F or ten-point scale, e.g.) relating to a party 302 of interest (to entity 192, e.g.) may be adjusted (downward in response to a customer complaint or other negative result described herein, e.g.) and used as determinants (compared by recognition modules 401-409 or invocation modules 791-798 each with a corresponding threshold as a requirement or exception, e.g.) in light of teachings herein.

Referring again to the method variants described above, respective operations may be performed by invoking one or more special-purpose modules 238 for generating or otherwise obtaining information. These may include one or more selective clip capture modules 353 or other characterization modules 205, 265; recognition modules 401-409 (configured to recognize one or more patterns 811-813 in speech data or image data or event sequence data, e.g.) or other data distillation modules 355; or decision modules 721-729 as described herein. Respective operations may likewise be performed by invoking one or more special-purpose modules 239 for presenting or otherwise using information. These may include one or more (instances of) presentation modules 215, 275; notification modules 371-378; or invocation modules 791-798 as described herein. As described herein, each of these special-purpose modules may be implemented as or operably coupled with transistor-based circuitry (as shown herein, e.g.) each having (a respective instance of) an event-sequencing structure (one or more instances of event-sequencing logic 350, 600, 800 described herein, e.g.). In some variants such structures comprise an arrangement of numerous transistors 271,272 and electrical nodes 241-244 (at decision-indicative voltage levels 231-234, e.g.) constructed and arranged to cause (to enable or trigger or directly perform or delegate, e.g.) the operation to occur (by directing an electrical current therethrough, e.g.) without substantial modification (without having to load instructions into a random-access memory for execution by a general-purpose processor, e.g.).

In some variants, with respect to mobile device experimentation, experimentation may be constrained responsive to one or more conditional parameters. By way of example only, parameter options/possibilities to be tested may be constrained based at least partially on power usage. For instance, the mobile device may intend to enable wireless communication with at least one bases station, but limit power output for such wireless communication to a particular power level (such as 100 mW). A battery may set limits or establish specified guidelines that constrain power usage, including but not limited to constraining power usage/charge drain over time. Accordingly, an experimentation module may trade (i) a selection of wireless standard being used or (ii) frequency or bandwidth of searching, for example, (instead of or in addition to transmit power) with power drain. Moreover, as another example, a power constraint may be selectively applied based at least partly on time of day or predicted time until a battery will next be charged. For instance, whether or to what stringency a power constraint is applied may depend on a time of day. Accordingly, there may be a greater concern on battery drain earlier in a day as compared to later when recharging typically occurs (a typical temporal pattern of charging—such as around noon in a car as well as starting at around midnight with a wall outlet—may also or alternatively be considered). From an alternative perspective, a battery level may be considered as a condition for ascertaining at least one associated antenna assembly configuration parameter (such as if selecting a wireless communication mode—or a group of wireless communication parameters). However, claimed subject matter is not limited to any particular described embodiments, implementations, examples, etc.

In some variants, an antenna configuration data structure may have separate entries for, or otherwise denote a difference between, uplink versus downlink. Appropriate uplink and downlink communication parameters may differ because multipath may affect the mobile device more than a base transceiver station, because different frequencies may be assigned to uplink versus downlink communications, or a hybrid that includes any one or more of these. However, claimed subject matter is not limited to any particular described embodiments, implementations, examples, etc.

In some variants, with respect to receiving commands or data at the mobile device from a base transceiver station, the mobile device may cooperate with the base transceiver station to obtain one or more wireless communication parameters. First, the base transceiver station may send to the mobile device or the mobile device may receive from the base transceiver station one or more wireless communication parameters that the mobile device may adopt. Second, the base transceiver station may send to the mobile device or the mobile device may receive from the base transceiver station at least some reception data from a perspective of the base transceiver station for the mobile device to incorporate into an automation process ascertaining what wireless communication parameters are to be implemented. Third, the mobile device and the base transceiver station may negotiate to determine a direction of a wireless signal that enables a reflection of a wireless signal off of an object between the mobile device and the base transceiver station (such as a bank shot may be planned and implemented) to facilitate signal propagation between the mobile device and the base transceiver station. Conducting a signal bank shot may be facilitated by using, for example, a 3D map depicting walls, furniture, terrain, vehicles, people, etc., and one or more reflection coefficients for proximate objects that indicate how or to what extent signals of particular frequencies can be expected to reflect off of an object. Cooperation between two wireless nodes may encompass, for example, any one or more of the above. However, claimed subject matter is not limited to any particular described embodiments, implementations, examples, etc.

In some variants, a data structure may link one or more wireless communication parameters with a given physical state of the mobile device. Thus, if the mobile device knows its spatial location (such as in terms of GPS coordinates or placement within a 3D map of a building), a group of wireless communication parameters (such as a set of antenna elements and respective phase delays) to be adopted to communicate with a particular base transceiver station may be ascertained from data structure. For certain example implementations, an orientation of the mobile device may be part of an input physical state to ascertain associated wireless communication parameters (such as if an orientation is expected to be user-determined autonomously). Alternatively, an orientation of the mobile device may be part of a group of wireless communication parameters that are output based on an e.g. spatial location of the mobile device (such as if the mobile device is expected to indicate to a user a particular mobile-device-orientation offering enhanced communication—which may be especially pertinent, for instance, if the mobile device is not being held during use, such as when a user has a wired or wireless headset, or if a user is sitting in a chair that swivels).

In some variants, an antenna configuration data structure may include one or more entries having a physical state field that is associated with or linked to a field having a group of wireless communication parameters. However, a data structure may additionally or alternatively include one or more of the following conditions or potential inputs: (a) prediction of an upcoming physical state, (b) a power availability at a transmitter or a receiver (or a power usage constraint), (c) a spatial location (or orientation) of the base transceiver station, (d) an availability of one or more personal auxiliary relay items, (e) a time of day, (f) other, potentially-interfering wireless traffic that is known of through self-detection or notification, (g) an expected radio activity (such as is a data intensive activity, such as media streaming, anticipated?), (h) a device type for the mobile device, (i) one or more antenna characteristics of the mobile device (such as a feasible beam pattern, a polarization sensitivity, a frequency response, an impedance, or a combination thereof, etc.), (j) a frequency band, (k) a signal encoding, (1) one or more environmental factors (such as humidity—certain frequencies propagate less well than others in higher humidity (such as 50 GHz signals attenuate in the presence of water), temperature, physical barriers—stationary or moving, approaching devices, or a combination thereof, etc.), or a hybrid that includes any one or more of these. However, claimed subject matter is not limited to any particular described embodiments, implementations, examples, etc.

In some variants, a wireless node may develop an antenna configuration data structure. By way of example only, a wireless node may store or record a physical state along with a corresponding signal quality in association with each other in a data structure. A physical state may correspond to a currently-existing physical state, a recently-tested physical state, or a hybrid that includes any one or more of these. For certain example implementations, an updated association may be stored if there are certain amounts of change to (i) a physical state or (ii) signal quality or if a certain amount of (iii) time has elapsed, or a hybrid that includes any one or more of these. Additionally or alternatively, for certain example implementations, a wireless node may replace or add to an existing entry if a new group of wireless communication parameters are discovered for a given physical state that provides superior signal quality. For certain example implementations, an entry of an antenna configuration data structure may include a time stamp representing when a value was determining, the mobile device or device type identifier of the mobile device that determined or was a source of a value, or a hybrid that includes any one or more of these. However, claimed subject matter is not limited to any particular described embodiments, implementations, examples, etc.

In some variants, new values for entries may be determined via interpolation or extrapolation from values associated with other physical states. For example, if data is available (such as from experimentation in transmit or receive postures) with respect to multiple tested orientations, it may be predicted how well antenna elements (or other wireless communication parameters) will work at other orientations. Additionally or alternatively, if data is available with respect to multiple tested spatial locations (including if a 3D map of a room is accessible or if know directional capabilities of an antenna), it may be predicted how well antenna elements (or other wireless communication parameters) will perform at other spatial locations. Even without a 3D map, if there are a sufficient number of measurements, then values for other, untested spatial locations may be predicted. For instance, if data values are available from several different paths taken by the mobile device around a room, then the mobile device can predict data values for other points in the room. For certain example implementations, one or more entries an antenna configuration data structure may have an indicator that a value is predicted, an indicator that a value has a particular level of reliability, or a hybrid that includes any one or more of these.

In some variants, network-side actors may acquire, build, create, maintain, share, or disseminate (or a combination thereof, e.g.) at least a portion of an antenna configuration data structure. Network-side actors may include, by way of example but not limitation, a cloud-based actor, an internet actor, a telecommunications service provider, a telecommunications equipment supplier, or a hybrid that includes any one or more of these. In some variants, network-side actors may acquire data fully or partially from the mobile device. For certain example implementations, the following data may be received from the mobile device: at least a portion of a physical state, one or more wireless communication parameters that were employed during the existence of the physical state, and corresponding signal quality. Additionally or alternatively, for certain example implementations, the following data may be received from the mobile device: physical state and wireless communication parameters that were employed during the existence of the physical state, and the following data may be received from a counterpart wireless node (such as the base transceiver station): signal quality based on a network-side reception.

In some variants, a network-side actor may send to the mobile device or the mobile device may receive from a network-side actor one or more portions of an antenna configuration data structure so as to download a cacheable part thereof. For certain example implementations, a part may be downloaded, or offered for download, based at least partially on any one or more of the following: (a) current spatial location; (b) physical state; (c) predicted spatial location; (d) predicted physical state; (e) device type, make, model, specifications, or combination thereof, etc. (such as memory capability, at least one user setting, or a specific physical antenna array traits, or a combination thereof, etc.); (f) a proximity to a boundary of current cached part (such as including, but not limited to, a consideration of predicted movement toward a boundary thereof); some combination thereof, or a hybrid that includes any one or more of these.

In some variants, a portable wireless node may account for or address environmental factors or concerns pertinent to wireless communication at, e.g., EHF. For certain example implementations, to avoid transmission through a human body, human tissue (such as hand, head, or a combination thereof, e.g.) may be detected using one or more of the following: (a) test beam emanation (such as analyze reflections from test beams), (b) a capacitive sensor (such as of a touchscreen), (c) a proximity detector (such as a light sensor), (d) a pressure sensor (such as determine where finger tips are placed), (e) a sound sensor (such as determine where a user's mouth is located), or a hybrid that includes any one or more of these.

In some embodiments, a handheld device 820 or other portable wireless node may interact with another portable wireless node (configured as an auxiliary relay item in a shoe or hat or other wearable article, e.g.) via a local linkage (Bluetooth®, e.g.). For certain example implementations, such auxiliary relay items may be engaged or utilized for any one or more of the following reasons: (a) a clearer path to another wireless node (such as to avoid a head or other human tissue or another blocking object), (b) more power availability, (c) more or differently-arranged antenna elements on the auxiliary relay item, (d) a different available frequency or wireless communication standard, or a hybrid that includes any one or more of these. By way of example only, a portable wireless node may roll over to an auxiliary relay item to relocate transmission power away from a head or if throughput drops where a user is currently holding a portable wireless node. For certain example implementations: (1) a portable wireless node may select between or among one or more auxiliary relay items (such as may determine when it is advisable to fallback to an auxiliary relay item using a protocol for communication between the mobile device and an auxiliary relay item); (2) an auxiliary relay item may be creating/using/updating an antenna configuration data structure in conjunction with or independent of a portable wireless node; (3) a spatial location of a wearable auxiliary relay item may be determine based at least partly on an attachment site to a body part; (4) a system may automatically determine presence/absence or location of wearable auxiliary relay items; (5) searches for suitable antenna configuration parameters by an auxiliary relay item may be constrained by battery power (such as power/battery-related technology described herein with respect to a portable wireless node may be applied to an auxiliary relay item, unless context dictates otherwise); (6) if multiple items are linked so as to enable or merely enhance communication or user functions if they are working together, then one or more of the multiple items may alert (such as visually, audibly, haptically, or a combination thereof, e.g.) if they are separated from each other beyond a threshold distance (such as beyond a range which enables using them together, such as if a user is driving away from a house with one of two interacting components); or some combination thereof.

In some variants, technologies described herein may be directly apparent to a user in one or more ways. For certain example implementations, a portable wireless node may offer a user one or more settings: (a) a size of a data structure being cached, (b) a slider or other mechanism to indicate between battery consumption versus signal acquisition or enhancement, (c) a slider or other mechanism to indicate between an acceptable energy radiation level (such as exposure to a body or head portion thereof) versus signal quality or bandwidth throughput, (d) ability to activate/sync/configure an auxiliary relay item (such as input a type), or a hybrid that includes any one or more of these. For certain example implementations, a user may indicate a desire to be notified of (such as via at least one setting): (a) a position or orientation option for a portable wireless node that offers improved communication (such as more bandwidth, less power, less interference, lower cost, or a combination thereof, e.g.), (b) an impending signal loss (such as if movement continues along a current direction based on signal degradation or entries in an antenna configuration data structure), or a hybrid that includes any one or more of these. For certain example implementations, notifications may be delivered by a portable wireless node to a user audibly, haptically, visually, or a combination thereof, e.g. for indicating a different position/orientation, impending signal loss, or a hybrid that includes any one or more of these.

In some variants, an extremely high frequency (EHF) communication (such as at 30-300 GHz, such as at 60 GHz in accordance with IEEE 802.1 lad) may be conducted by wireless node that is also capable of utilizing other frequency bands or other wireless communication standards. To facilitate such interoperability, a wireless node may determine (i) whether or when to switch to another frequency band or another wireless communication standard or (ii) whether or when to share bandwidth demands with another frequency band or another wireless communication standard. For certain example implementations, other frequency bands may include, but are not limited to, (a) 2.4 GHz, 3.6 GHz, 5 GHz, or a combination thereof, e.g.; (b) 700/800 MHz, 900 MHz, 1800 MHZ, 1700/1900 MHz, 2500 MHz, 3500 MHz, or a combination thereof, e.g.; or a hybrid that includes any one or more of these. For certain example implementations, other wireless communication standards may include, but are not limited to, (a) IEEE 802.11b, 802.11g, 802.11a, 802.11n, 802.11ac, or a combination thereof, e.g.; (b) GSM/EDGE, CDMA, UMTS/HSPA, LTE, WiMAX; or a hybrid that includes any one or more of these. However, claimed subject matter is not limited to any particular described embodiments, implementations, examples, e.g.

In some variants, a wireless node may choose to switch frequency or wireless standard or may choose to share communication across two or more frequencies or wireless standards. For certain example implementations, one or more of a number of factors may be considered for switching versus sharing decisions. First, a wireless node may switch if another frequency band or standard can handle current bandwidth demands while a current one cannot. Second, a wireless node may switch if another frequency band or standard has a lower, or at least no higher, cost. Third, a wireless node may switch if a current frequency is experiencing attenuation but another frequency is likely not to experience the same attenuation (such as if body tissue is currently attenuating a 60 GHz signal, but the mobile device can switch to a lower frequency signal below 10 GHz). Fourth, a wireless node may share bandwidth demands if a current frequency or standard is not providing a sufficiently fast or strong connection, but another frequency or standard has a higher cost or insufficient bandwidth capability to meet current bandwidth demands. Additional or alternative factors for deciding between switching and sharing may be considered. For certain example implementations, one or more of a number of factors may prompt a wireless node to consider sharing or switching. First, a signal quality may drop below a threshold using a current frequency or standard. Second, no group of wireless communication parameters offering superior performance may be determinable by a wireless node via experimentation. Third, no entry in a wireless communication configuration data structure for a current or impending physical state (or set of conditions generally) may be ascertained. Additional or alternative factors for deciding whether to consider switching versus sharing may be incorporated into a wireless node's automation. However, claimed subject matter is not limited to any particular described embodiments, implementations, examples, e.g.

In some variants, a coordinated management system may be implemented where multiple wireless nodes occupy a given physical region, with the management system coordinating various signal strengths, antenna directions, polarizations, features, or a hybrid that includes any one or more of these. Coordination may enable a greater number of nodes within or a more efficient use of available spectrum within a given physical region. However, claimed subject matter is not limited to any particular described embodiments, implementations, examples, e.g.

In some variants, a coordinated management system may be constituted in a centralized or a distributed manner. For a centralized coordinated management system, in accordance with certain example implementations, an access point, the base transceiver station, a mobile switching center, a fixed wireless node, an internet node, a telecom node, or a combination thereof, e.g., may coordinate a number of portable wireless nodes across a single “cell” or multiple cells. For a distributed coordinated management system, in accordance with certain example implementations, two or more portable wireless nodes, separately from or in conjunction with at least one network-infrastructure-based node—such as a fixed wireless node or a telecom node or an internet node, may coordinate their own individual wireless signals. Coordination may be based at least partially on their own sensor readings, including but not limited to received signals, or based at least partially on using coordination-specific data received from or exchanged with other portable wireless nodes or with a fixed wireless nodes, such as the base transceiver station. For a hybrid coordinated management system, in accordance with certain example implementations, there may be some decentralized efforts by portable wireless nodes with overarching efforts by one or more network-infrastructure-based nodes for centralized oversight. However, claimed subject matter is not limited to any particular described embodiments, implementations, examples, etc.

In some variants, one or more factors may be separately or jointly considered in conjunction with, or as part of, an analysis to facilitate coordination. First, available frequency bands (in a given region or to a particular portable wireless node) may be considered. Different bands have different amounts or levels of absorption or other loss, dispersion, scattering, reflection, or a hybrid that includes any one or more of these. By way of example only, 60 GHz typically has more attenuation than 5 GHz. Thus, although 60 GHz generally propagates a relatively shorter distance, it can correspondingly be reused in smaller spaces. At 60 GHz, reflections may enable “bank shots” off of proximate objects. Two devices may determine to perform a bank shot via negotiation, or a centralized coordinator may order them to perform one. Furthermore, devices transmitting at higher frequencies may utilize smaller antenna elements that accommodate their smaller/shorter wavelengths. A physical size of a particular wavelength aperture may generally be smaller at higher frequencies. Relatively smaller devices can therefore implement beamforming at 60 GHz, for example, even if they would be unable to do so at 1800 MHz, or even 5 GHz. Second, governmental restrictions may be considered. In some contexts statutes or regulations may stipulate or require certain transmission maximums or reception capabilities. By way of example only, a signal strength may be limited at particular frequencies. Third, licensing constraints (such as with regard to available frequencies or particular uses thereof) may be considered. Licensing constraints may flow from a governmental entity, from a corporation to the mobile device or mobile device user (such as contractual obligations), or a hybrid that includes any one or more of these. Fourth, different or particular device types in a given physical region that are trying to share spectrum may be considered. For example, “permanent” characteristics may be considered: (a) antenna features (such as beam pattern capabilities, polarization sensitivity, frequency response, impedance, or a combination thereof, e.g.), (b) processing capability, or a hybrid that includes any one or more of these. As another example, current settings of a device (such as user-established settings, OS-specified settings, app-determined settings, or a combination thereof, e.g.) may be considered: (a) frequency selection from among multiple possible frequencies, (b) signal encoding selection from among multiple possible encoding schemes, (c) user-imposed restraints (such as based on cost, power, battery life, or a combination thereof, e.g.), or a hybrid that includes any one or more of these. As yet another example, current status levels or conditions of a device may be considered: (a) signal to noise ratio (SNR), (b) signal strength, (c) power constraints or battery status, (d) available processing bandwidth, (e) location, (f) expected radio activity level (such as whether an activity is anticipated to be data intensive (e.g. media streaming)), (g) orientation, (h) operating state (such as connected to a Wi-Fi network or not, access through near field communication (NFC), or a combination thereof, e.g.), or a hybrid that includes any one or more of these. Fifth, environmental characteristics may be considered. For example, physical barriers (such as walls, trees, billboards, etc.; those obtainable from one or more Google Earth or crowd-sourced 3D building data or other maps; or a combination thereof; etc.) may be considered. Other environmental characteristics may include, but are not limited to, other approaching devices (such as their locations or transmitting characteristics), humidity, temperature, or a hybrid that includes any one or more of these. However, claimed subject matter is not limited to any particular described embodiments, implementations, examples, etc.

In some variants, coordination opportunities may include, but are not limited to, bank shots or beamforming. First, bank shots may be planned or implemented between at least two wireless nodes to avoid a wall or other obstacle, if a vehicle is detected to be approaching and will be temporarily block a line-of-sight transmission path, or a hybrid that includes any one or more of these. Second, beamforming may be achieved with, by way of example but not limitation, an antenna with multiple elements, a phased array, a meta-material antenna, or a hybrid that includes any one or more of these. An aimed beam may reach a target with less relative power (such as in comparison to an omnidirectional transmission a beam may reach a further distance (with a narrower footprint) using a same power level). Further with respect to coordination, an omnidirectional transmission may be used if a target or counterpart wireless node is moving (or if a transmitting node is moving), but beamforming may be used if a target is stationary (or slowly moving) (or if a transmitting node is not moving). Aiming a beam may be accomplished through “trial and error”. As a first example, multiple beams may be sent out (such as fully or partially simultaneously or over time) with different indicators, and an intended recipient may be asked for an indicator that they received strongest to determine a good beam pattern for that recipient. As a second example, two nodes may send out beams until they connect. As a third example, a wireless node may sweep beams circularly until a directional angle (such as azimuth angle) is discovered that makes contact with an intended wireless target, and a wireless node may then slice up or down until it hones in to find an elevation or a zenith angle. However, claimed subject matter is not limited to any particular described embodiments, implementations, examples, etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application. While various system, method, article of manufacture, or other embodiments or aspects have been disclosed above, also, other combinations of embodiments or aspects will be apparent to those skilled in the art in view of the above disclosure. The various embodiments and aspects disclosed above are for purposes of illustration and are not intended to be limiting, with the true scope and spirit being indicated in the final claim set that follows.

1-4. (canceled)

5. An intelligence amplification system relating to impairment in a first individual and to an expression of a second individual, the system comprising:
transistor-based circuitry configured to obtain an identification of the second individual;
transistor-based circuitry configured to decide whether or not to adjust a performance evaluation of the second individual as an automatic and conditional response partly based on the identification of the second individual and partly based on an indication of the first individual not reacting positively to the expression of the second individual, the automatic and conditional response partly based on the identification of the second individual and partly based on the indication of the first individual not reacting positively to the expression of the second individual including both selectively retaining a recorded data component of the expression of the second individual and adjusting the performance evaluation of the second individual.

6. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
a non-transitory medium bearing a conditional communication decision whether or not to establish an intercommunication to a third individual as another automatic and conditional response partly based on the identification of the second individual and partly based on the indication of the first individual not reacting positively to the expression of the second individual.

7. The intelligence amplification system of claim 5 further comprising:
transistor-based circuitry configured to decide whether or not to adjust an evaluation of content authored by the second individual as an automatic and conditional response partly based on the identification of the second individual and partly based on an indication of the first individual not reacting positively to the expression of the second individual.

8. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
a non-transitory medium bearing a manifestation of shrinking approval of the second individual as another automatic and conditional response partly based on the identification of the second individual and partly based on the indication of the first individual not reacting positively to the expression of the second individual.

9. The intelligence amplification system of claim 5 further comprising:
transistor-based circuitry configured to decide whether or not to facilitate a communication to a third individual as an automatic and conditional response partly based on the identification of the second individual and partly based on an indication of the first individual not reacting positively to the expression of the second individual.

10. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
a non-transitory medium bearing a manifestation of a concession to the first individual as another automatic and conditional response partly based on the identification of the second individual and partly based on the indication of the first individual not reacting positively to the expression of the second individual.

11. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
a non-transitory medium in which a record uniquely links a vehicle identification number with an identifier of the second individual.

12. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
a device manifesting an association with an entity that includes a third individual and wearable by the second individual and in which a record uniquely links an identifier of the device with an identifier of the second individual.

13. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
transistor-based circuitry configured to determine whether or not the second individual has manifested impatience by speaking within a time interval less than a threshold after the first individual arriving at a point of sale, the threshold being less than 5 seconds.

14. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
transistor-based circuitry configured to cause a disruptive emission at a point of sale as an automatic and conditional response to the second individual speaking within a time interval less than a threshold after the first individual arriving at a point of sale, the threshold being in the range of 0.5 to 5 seconds.

15. The intelligence amplification system of claim 5 further comprising:
the transistor-based circuitry configured to decide whether or not to adjust the performance evaluation of the second individual as the automatic and conditional response partly based on the identification of the second individual and partly based on the indication of the first individual not reacting positively to the expression of the second individual comprising:
transistor-based circuitry configured to implement noise cancellation as a disruptive emission at a point of sale as an automatic and conditional response to the second individual speaking within a time interval less than a threshold after the first individual arriving at a point of sale, the threshold being less than 5 seconds, the noise cancellation being effective to mitigate the first individual hearing an utterance of the second individual.

16. The intelligence amplification system of claim 5 further comprising:
transistor-based circuitry configured to provide guidance via an earphone to the first individual as an automatic and conditional response partly based on the identification of the second individual and partly based on the indication of the first individual not reacting positively to the expression of the second individual.

17. An intelligence amplification method relating to impairment in a first individual and to an expression of a second individual, the method comprising:
obtaining an identification of the second individual;
invoking transistor-based circuitry configured to decide whether or not to adjust a performance evaluation of the second individual as an automatic and conditional response partly based on the identification of the second individual and partly based on an indication of the first individual not reacting positively to the expression of the second individual, the automatic and conditional response partly based on the identification of the second individual and partly based on the indication of the first individual not reacting positively to the expression of the second individual including both selectively retaining a recorded data component of the expression of the second individual and adjusting the performance evaluation of the second individual.

18. The intelligence amplification method of claim 17 further comprising:
the invoking transistor-based circuitry configured to decide whether or not to adjust the performance evaluation of the second individual as the automatic and conditional response partly based on the identification of the second individual and partly based on the indication of the first individual not reacting positively to the expression of the second individual comprising:
detecting a facial expression made by the first individual as the indication of the first individual not reacting positively to the expression of the second individual.

19. The intelligence amplification method of claim 17 further comprising:
the invoking transistor-based circuitry configured to decide whether or not to adjust the performance evaluation of the second individual as the automatic and conditional response partly based on the identification of the second individual and partly based on the indication of the first individual not reacting positively to the expression of the second individual comprising:
deciding to adjust the performance evaluation of the second individual as the automatic and conditional response partly based on the identification of the second individual and partly based on the indication of the first individual not reacting positively to the expression of the second individual, the recorded data component of the expression of the second individual being something said by the employee.

20. The intelligence amplification method of claim 17 further comprising:
the invoking transistor-based circuitry configured to decide whether or not to adjust the performance evaluation of the second individual as the automatic and conditional response partly based on the identification of the second individual and partly based on the indication of the first individual not reacting positively to the expression of the second individual comprising:
broadcasting a message including the identification of the second individual and a categorization of the second individual.

21. The intelligence amplification method of claim 17 further comprising:
the invoking transistor-based circuitry configured to decide whether or not to adjust the performance evaluation of the second individual as the automatic and conditional response partly based on the identification of the second individual and partly based on the indication of the first individual not reacting positively to the expression of the second individual comprising:
broadcasting a message associating the second individual with the performance evaluation.

22. The intelligence amplification method of claim 17 further comprising:
the invoking transistor-based circuitry configured to decide whether or not to adjust the performance evaluation of the second individual as the automatic and conditional response partly based on the identification of the second individual and partly based on the indication of the first individual not reacting positively to the expression of the second individual comprising:
detecting an irritated vocalization made by the first individual as the indication of the first individual not reacting positively to the expression of the second individual.

23. The intelligence amplification method of claim 17 further comprising:
the invoking transistor-based circuitry configured to decide whether or not to adjust the performance evaluation of the second individual as the automatic and conditional response partly based on the identification of the second individual and partly based on the indication of the first individual not reacting positively to the expression of the second individual comprising:
identifying an employee at a point of sale as the identification of the second individual; and
detecting that the employee at the point of sale has spoken as the recorded data component of the expression of the second individual.

24. The intelligence amplification method of claim 17 further comprising:
the invoking transistor-based circuitry configured to decide whether or not to adjust the performance evaluation of the second individual as the automatic and conditional response partly based on the identification of the second individual and partly based on the indication of the first individual not reacting positively to the expression of the second individual comprising:
deciding to adjust the performance evaluation of the second individual as the automatic and conditional response partly based on the identification of the second individual and partly based on the indication of the first individual not reacting positively to the expression of the second individual, the performance evaluation being a downward adjustment associated with a transaction of the employee at the point of sale.
